(19) United States
(12) Patent Application Publication
(10) Pub. No.: US 2024/0092437 A1
(43) Pub. Date: Mar. 21, 2024

(54) RESILIENT WHEEL WITH LOW-FRICTION AND WEAR RESISTANT SIDEWALL AND TRACK SYSTEM HAVING SAME

(71) Applicant: SOUCY INTERNATIONAL INC., Drummondville (CA)

(72) Inventors: Jeremie AUBIN-MARCHAND, St-Hugues (CA); Marc NADEAU, Drummondville (CA)

(21) Appl. No.: 18/470,528

(22) Filed: Sep. 20, 2023

Related U.S. Application Data
(60) Provisional application No. 63/420,276, filed on Oct. 28, 2022.
(60) Provisional application No. 63/408,776, filed on Sep. 21, 2022.

(51) Int. Cl. B62D 55/14

(52) U.S. Cl. CPC B62D 55/145

(57) ABSTRACT

A resilient component for a wheel of a track system is disclosed. The resilient component includes a resilient body and a wear element. The resilient body defines a hub aperture for at least partially receiving a hub component. The resilient body extends radially outwardly from the hub aperture, and defines a first lateral sidewall and a second lateral sidewall, the first and second lateral sidewalls being spaced apart. The wear element is connectable to one of the first and second lateral sidewalls, and at least partially surrounds the hub aperture. A wheel having the resilient component and the hub component is also disclosed. A track assembly having the wheel is also disclosed.

### CROSS-REFERENCE TO RELATED APPLICATIONS

The present application claims priority to U.S. Provisional Patent Application No. 63/408,776, filed Sep. 21, 2022, and U.S. Provisional Patent Application No. 63/420,276, filed Oct. 28, 2022, both of which are incorporated by reference herein in their entirety.

### FIELD OF TECHNOLOGY

The present technology generally relates to wheels for track systems, specifically resilient wheels, and track systems comprising such resilient wheels.

### BACKGROUND INFORMATION

Certain vehicles, such as, recreational vehicles (e.g., all-terrain vehicles, utility-terrain vehicles, side-by-side vehicles, etc.), agricultural vehicles (e.g., harvesters, combines, tractors, etc.) or construction vehicles (e.g., trucks, front-end loaders, etc.) are equipped with track systems.

When conventional track systems travel over laterally uneven surfaces, wheels can come into contact with drive lugs, which can result in premature wear of the drive lugs of the track and/or premature wear of the wheels. Additionally, the track system can be detracked. Additionally, travelling over laterally uneven surfaces with conventional track systems can lead to uneven load distribution across a width of the track, which can result in premature wear of the track of the track system.

Furthermore, when track systems are used on soft and/or loose ground (e.g., muddy, snowy, etc.), accumulation of the ground material on and/or around wheels (sometimes referred to as “build-up”) can be concerning, since this build-up on and/or around wheels can vary the diameter thereof, which in turn can vary the tension in the endless tracks of the track systems.

One conventional way to avoid build-up on wheels of a track system is to avoid using wide wheels. However, wide wheels are often desirable to decrease local point load of the wheels (i.e., pressure) on their endless tracks, thereby allowing a more flexible endless track to be used (e.g., an endless track made of softer resilient material and/or with fewer reinforcing elements within its carcass). In addition, a more flexible endless track may also reduce rolling resistance and manufacturing costs in some cases.

One other way that is known in the art to avoid build-up on wheels of a track system is to use deformable wheels, (i.e., wheels capable of radial resilient deformation). The radial deformation can impede debris from adhering to the wheel. The deformable wheels of the present technology may also be capable of absorbing at least a portion of the impacts, shocks and/or vibration induced when the track systems travel on uneven ground.

Typically, these deformable wheels can be used as support wheels, idler wheels or

a combination of both (e.g., U.S. Pat. No. 9,033,430, incorporated herein by reference), can be pneumatic (e.g., U.S. Pat. No. 5,462,345, incorporated herein by reference) or non-pneumatic by being configured as a solid body made of resilient material (e.g., U.S. Pat. No. 9,033,430, incorporated herein by reference) or as a hollow body made of resilient material (e.g., US 20200277012, incorporated herein by reference).

One of the roles of the idler wheels (and/or support wheels in some cases) of a track system is typically to guide the track laterally to maintain its alignment, notably to avoid potential detracking, among other things. More precisely, alignment of the endless track can be maintained via engagement between a portion of an inner surface of the endless track and a side of one or more of the idler wheel and/or one or more of the support wheels, such that the one or more of the idler and/or support wheels act as a stopper or a boundary, and thus limits lateral movement of the endless track to avoid potential detracking. Detracking can especially occur when a lateral force is applied on the track system (e.g.: when the track system is steered, when the vehicle travels in a sidehill orientation, etc.). It is understood that the sides of the idler wheels and/or sides of the support wheels can often be in contact with the portion of the inner surface of the endless track, which can generate friction and cause premature wear of the wheels and/or the endless track. Wear resulting from contact between the side of the wheels (e.g., support wheels or idler wheels) and the portion of the inner surface of the endless track (traction and/or guide teeth) can be a major issue affecting the durability of the components of a track system.

The prior art has proposed to add “wear rings” or “wear parts” to sidewalls of the wheels for extending the lives of the wheels and the track. These “wear rings” and “wear parts” are made of hard and resistant materials, or of a material with a low coefficient of friction (e.g., UHMW-PE). These “wear rings” and “wear parts” are typically installed on sidewalls of wheels via screwing (e.g., U.S. Pat. No. 9,663,163, incorporated herein by reference), via snap-fit (e.g., U.S. Pat. No. 10,640,161, incorporated herein by reference) or via adhesive/mechanical interlock (e.g., U.S. Pat. No. 5,141,299, incorporated herein by reference), for example, to the wheel sidewalls. This is a relatively effective solution, as these wearing parts are inexpensive and easy to replace and is efficient on rigid wheels. However, this solution is not suitable for deformable wheels.

U.S. Pat. No. 5,462,345, incorporated herein by reference, teaches the addition of resilient pads to reinforce the sidewall. This patent focuses on heavy vehicles and mentions that the wheels are resilient, giving as an example a tire or a rubber coating.

There is thus a need in the art for ways to reducing wear on wheels of track systems.

### SUMMARY OF TECHNOLOGY

It is an object of the present technology to ameliorate at least some of the inconveniences present in the prior art.

According to one aspect of the present technology, there is provided a resilient component for a wheel of a track system. The resilient component includes a resilient body and a wear element. The resilient body defines a hub aperture for at least partially receiving a hub component, extends radially outwardly from the hub aperture, and defines a first lateral sidewall and a second lateral sidewall, the first and second lateral sidewalls being spaced apart. The wear element is connectable to one of the first and second lateral sidewalls, the wear element at least partially surrounding the hub aperture and projecting at least partially from the one of the first and second lateral sidewalls.

In some embodiments, the resilient body is deformable by a first amount when the wear element is disconnected from the resilient body, the resilient body is deformable by a second amount when the wear element is connected to the resilient body, and the first amount is generally similar to the second amount.

In some embodiments, the resilient body has a first modulus of elasticity when the wear element is disconnected from the resilient body, the resilient body has a second modulus of elasticity when the wear element is connected to the resilient deformable body; and the first modulus of elasticity is generally similar to the second modulus of elasticity.

In some embodiments, the resilient body is resiliently deformable.

In some embodiments, the wear element is deformable.

In some embodiments, the wear element includes an anchoring portion for anchoring the wear element to the resilient body.

In some embodiments, the anchoring portion extends in at least one of a radial direction of the resilient component and an axial direction of the resilient component.

In some embodiments, the anchoring portion includes an enlarged portion.

In some embodiments, the wear element defines a plurality of apertures.

In some embodiments, the wear element is a wear ring.

In some embodiments, the wear ring has a circular cross-section.

In some embodiments, the wear ring has a rectangular cross-section.

In some embodiments, the wear element extends axially within the resilient body by about half of an axial length of the resilient body.

In some embodiments, the wear element has an axial thickness of between about 1 mm and about 5 mm.

In some embodiments, the wear element includes a plurality of wear element segments, each one of the wear element segments being circumferentially spaced from an other one of the plurality of wear element segments.

In some embodiments, the resilient component comprises a plurality of wear elements, and the wear element is one of the plurality of wear elements.

In some embodiments, each one of the plurality of wear elements is a spherical wear element.

In some embodiments, the resilient body is made of foam.

In some embodiments, the foam is a closed-cell foam.

In some embodiments, the closed-cell foam is polyurethane closed cell foam.

In some embodiments, the wear element is made of a material having a low coefficient of friction with rubber.

In some embodiments, the wear element is made of ultra-high-molecular-weight polyethylene UHME-PE.

In some embodiments, the wear element is a coating of wear element particles.

In some embodiments, the wear element is selectively connected to the resilient body.

In some embodiments, the wear element includes a connecting portion for connecting with the resilient body, and a wear portion connectable to the connecting portion.

In some embodiments, the resilient body is connectable to the hub component by a chemical bond.

In some embodiments, the resilient body is connectable to the hub component by a mechanical interlock.

In some embodiments, the resilient body is connectable to the hub component by an interference fit.

In some embodiments, the hub component defines a first perimeter, the hub aperture defines a second perimeter, and the first perimeter is greater than the second perimeter.

In some embodiments, the resilient body is hermetically connectable to the hub member.

In some embodiments, the connecting portion is made of a polymeric material.

In some embodiments, the resilient body includes at least two strengthening folds.

In some embodiments, the resilient component is for use as an idler wheel.

In some embodiments, the resilient component is for use as a non-pneumatic wheel.

According to another aspect of the present technology, there is provided a resilient wheel for a track system. The resilient wheel includes a hub component and a resilient component. The resilient component includes a resilient body and a wear element. The resilient body defines a hub aperture for receiving the hub component, extends radially outwardly from the hub aperture so as to define a first lateral sidewall and a second lateral sidewall, the first and second lateral sidewalls being spaced apart. The wear element is connected to one of the first and second lateral sidewalls, surrounds, at least partially, the hub aperture and projects, at least partially, from the one of the first and second lateral sidewalls.

In some embodiments, the resilient wheel is a non-pneumatic wheel.

In some embodiments, the resilient body is deformable by a first amount when the wear element is disconnected from the resilient body, the resilient body is deformable by a second amount when the wear element is connected to the resilient body; and the first amount is generally similar to the second amount.

In some embodiments, the resilient body has a first modulus of elasticity when the wear element is disconnected from the resilient body, the resilient body has a second modulus of elasticity when the wear element is connected to the resilient deformable body, and the first modulus of elasticity is generally similar to the second modulus of elasticity.

In some embodiments, the resilient body is resiliently deformable.

In some embodiments, the wear element is deformable.

In some embodiments, the wear element includes an anchoring portion for anchoring the wear element to the resilient body.

In some embodiments, the anchoring portion extends in at least one of a radial direction of the resilient component and an axial direction of the resilient component.

In some embodiments, the anchoring portion includes an enlarged portion.

In some embodiments, the wear element defines a plurality of apertures.

In some embodiments, the wear element is a wear ring.

In some embodiments, the wear ring has a circular cross-section.

In some embodiments, the wear ring has a rectangular cross-section.

In some embodiments, the wear element extends axially within the resilient body by about half of an axial length of the resilient body.

In some embodiments, the wear element has an axial thickness of between about 1 mm and about 5 mm.

In some embodiments, the wear element includes a plurality of wear element segments, each one of the wear element segments being circumferentially spaced from another one of the plurality of wear element segments.

In some embodiments, the resilient component comprises a plurality of wear elements, and the wear element is one of the plurality of wear elements.

In some embodiments, each one of the plurality of wear elements is a spherical wear element.

In some embodiments, the resilient body is made of foam.

In some embodiments, the foam is a closed-cell foam.

In some embodiments, the closed-cell foam is polyurethane closed cell foam.

In some embodiments, the wear element is made of a material having a low coefficient of friction with rubber.

In some embodiments, the wear element is made of ultra-high-molecular-weight polyethylene UHME-PE.

In some embodiments, the wear element is a coating of wear element particles.

In some embodiments, the wear element is selectively connected to the resilient body.

In some embodiments, the wear element includes a connecting portion for connecting with the resilient body, and a wear portion connectable to the connecting portion.

In some embodiments, the resilient body is connectable to the hub component by a chemical bond.

In some embodiments, the resilient body is connectable to the hub component by a mechanical interlock.

In some embodiments, the resilient body is connectable to the hub component by an interference fit.

In some embodiments, the hub component defines a first perimeter, the hub aperture defines a second perimeter, and the first perimeter is greater than the second perimeter.

In some embodiments, the resilient body is hermetically connectable to the hub member.

In some embodiments, the connecting portion is made of a polymeric material.

In some embodiments, the resilient body includes at least two strengthening folds.

In some embodiments, the resilient component is for use as an idler wheel.

In some embodiments, the hub component has a positioning feature, and the resilient wheel further includes a positioning element connectable to the resilient body, the positioning element being complementary to the positioning feature of the hub component for positioning the hub component relative to the resilient body.

In some embodiments, the resilient wheel further comprises a retaining ring, the hub component includes a retaining portion for engaging with the retaining ring, and the retaining ring being configured to axially retain the resilient body to the hub component.

A track system comprising a frame, at least one wheel assembly comprising a wheel according to the above aspect or according to the above aspect and one or more of the above embodiments, the at least one wheel assembly being connected to the frame, and an endless track surrounding the frame and the at least one wheel assembly.

According to another aspect of the present technology, there is provided a track system comprising a frame, at least one idler wheel assembly connected to the frame, at least one support wheel assembly connected to the frame, and an endless track. The at least one idler wheel assembly includes at least one resilient wheel, which includes a first hub component, and a first resilient component. The first resilient component includes a first resilient body and first wear element. The first resilient body defines a first hub aperture for receiving the first hub component, extends radially outwardly from the first hub aperture so as to define a first lateral sidewall and a second lateral sidewall, the first and second lateral sidewalls being spaced apart. The first wear element is connected to one of the first and second lateral sidewalls, surrounds, at least partially, the first hub aperture and projects, at least partially, from the one of the first and second lateral sidewalls. The at least one support wheel assembly includes at least one resilient wheel, which includes a second hub component, and a second resilient component. The second resilient component includes a second resilient body and a second wear element. The second resilient body defines a second hub aperture for receiving the second hub component, extends radially outwardly from the second hub aperture so as to define a third lateral sidewall and a fourth lateral sidewall, the third and fourth lateral sidewalls being spaced apart. The second wear element is connected to one of the third and fourth lateral sidewalls, surrounds, at least partially, the second hub aperture and projects, at least partially, from the one of the third and fourth lateral sidewalls. The endless track surrounds the frame, the at least one idler wheel assembly and the at least one support wheel assembly, and includes a plurality of longitudinally spaced lugs. A lateral distance between one of first and second lateral sidewalls and a corresponding lateral surface of one of the plurality of lugs is less than a lateral distance between a corresponding one of the third and fourth lateral sidewalls and a corresponding lateral surface of one of the plurality of lugs.

According to another aspect of the present technology, there is provided a method for manufacturing part of resilient wheel for a track system, the method including forming a resilient body configured to be connectable to a hub component, and configured to receive a wear element.

According to another aspect of the present technology, there is provided a method for manufacturing a resilient component for a resilient wheel of a track system, the method including forming a resilient body configured to be connectable to a hub component, and connecting a wear element to the resilient body.

According to another aspect of the present technology, there is provided a method for manufacturing a resilient wheel for a track system, the method comprising connecting a resilient body to a hub component, and connecting a wear element to the resilient body.

According to another aspect of the present technology, there is provided a method for manufacturing a resilient component for a resilient wheel, the method comprising forming the resilient body, and inserting a wear element in the resilient body.

In the context of the following description, “outwardly” or “outward” means away from a longitudinal center plane of the track system, and “inwardly” or “inward” means toward the longitudinal center plane. In addition, in the context of the following description, “longitudinally” means in a direction parallel to the longitudinal center plane of the track system in a plane parallel to flat level ground, “laterally” means in a direction perpendicular to the longitudinal center plane in a plane parallel to flat level ground, and “generally vertically” means in a direction contained in the longitudinal center plane along a height direction of the track system generally perpendicular to flat level ground. Note that in the Figures, a “+” symbol is used to indicate an axis of rotation. In the context of the present technology, the term “axis” may be used to indicate an axis of rotation. Also, the terms “pivot assembly” and “wheel assemblies” include all the necessary structure (bearing structures, pins, axles and other components) to permit a structure/wheel to pivot/rotate about an axis, as the case may be.

In the present description, the “leading” components are components located towards the front of the vehicle defined consistently with the vehicle's forward direction of travel, and the “trailing” components are components located towards the rear of the vehicle defined consistently with the vehicle's forward direction of travel. In the following description and accompanying Figures, the track system is configured to be attached to a right side of the chassis of the vehicle. In the context of the present technology, the qualification of a wheel assembly as “at least indirectly connected” includes a wheel assembly that is directly connected to the at least one wheel-bearing frame member as well as a wheel assembly that is connected to the wheel-bearing frame member through an intermediate structure or structures, be they intermediate frame members or otherwise.

In the context of the present specification, unless expressly provided otherwise, the words “first”, “second”, “third”, etc. have been used as adjectives only for the purpose of allowing for distinction between the nouns that they modify from one another, and not for the purpose of describing any particular relationship between those nouns.

It must be noted that, as used in this specification and the appended claims, the singular form “a”, “an” and “the” include plural referents unless the context clearly dictates otherwise.

As used herein, the term “about” in the context of a given value or range refers to a value or range that is within 20%, preferably within 10%, and more preferably within 5% of the given value or range.

As used herein, the term “and/or” is to be taken as specific disclosure of each of the two specified features or components with or without the other. For example, “A and/or B” is to be taken as specific disclosure of each of (i) A, (ii) B and (iii) A and B, just as if each is set out individually herein.

Implementations of the present technology each have at least one of the above-mentioned objects and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects, and advantages of implementations of the present technology will become apparent from the following description, the accompanying drawings, and the appended claims.

### BRIEF DESCRIPTION OF THE FIGS.

For a better understanding of the present technology, as well as other aspects and further features thereof, reference is made to the following description which is to be used in conjunction with the accompanying drawings, where:

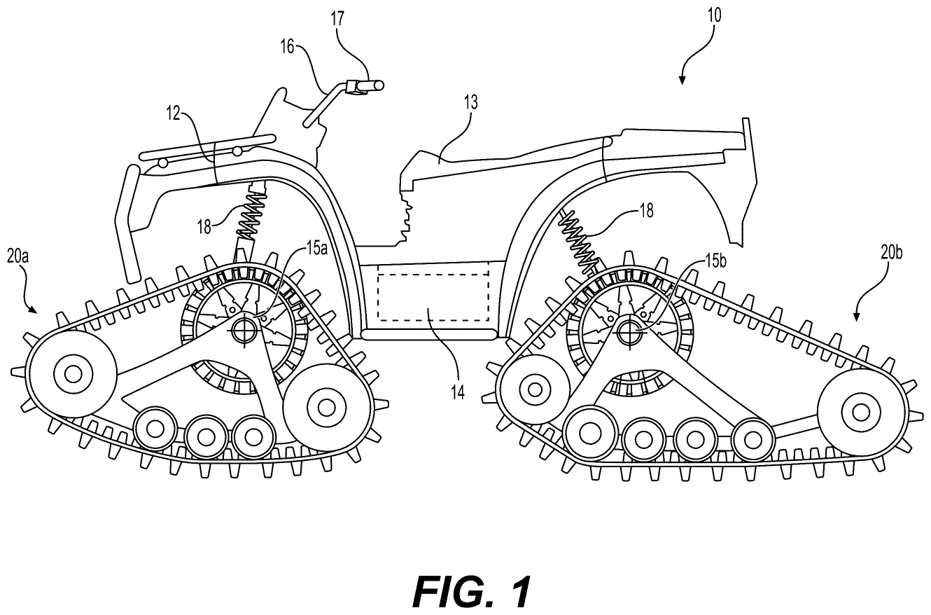

FIG. 1 is a left side elevation view of an all-terrain vehicle having track systems according to embodiments of the present technology;

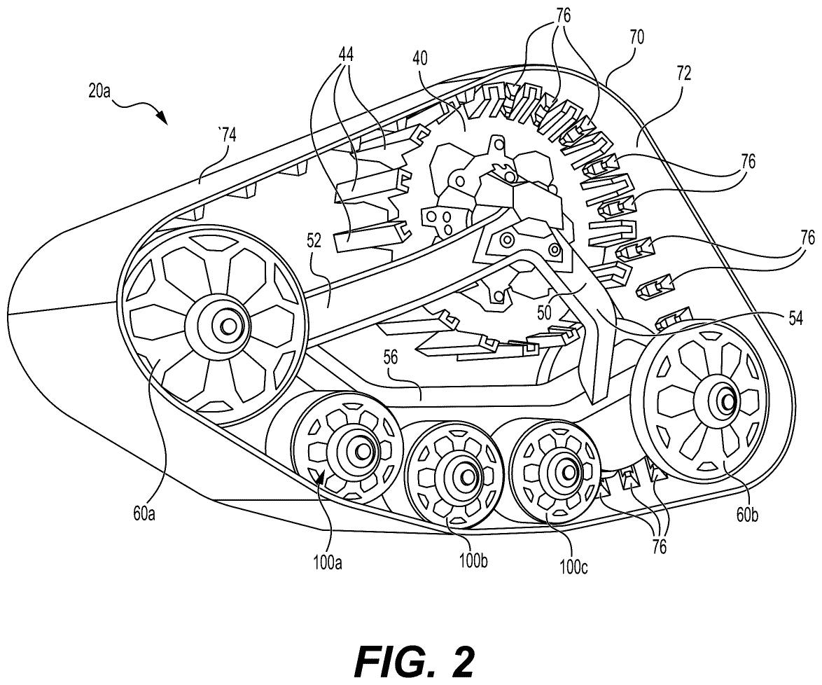

FIG. 2 is a perspective view taken from a bottom, front, left side of one the track systems of FIG. 1;

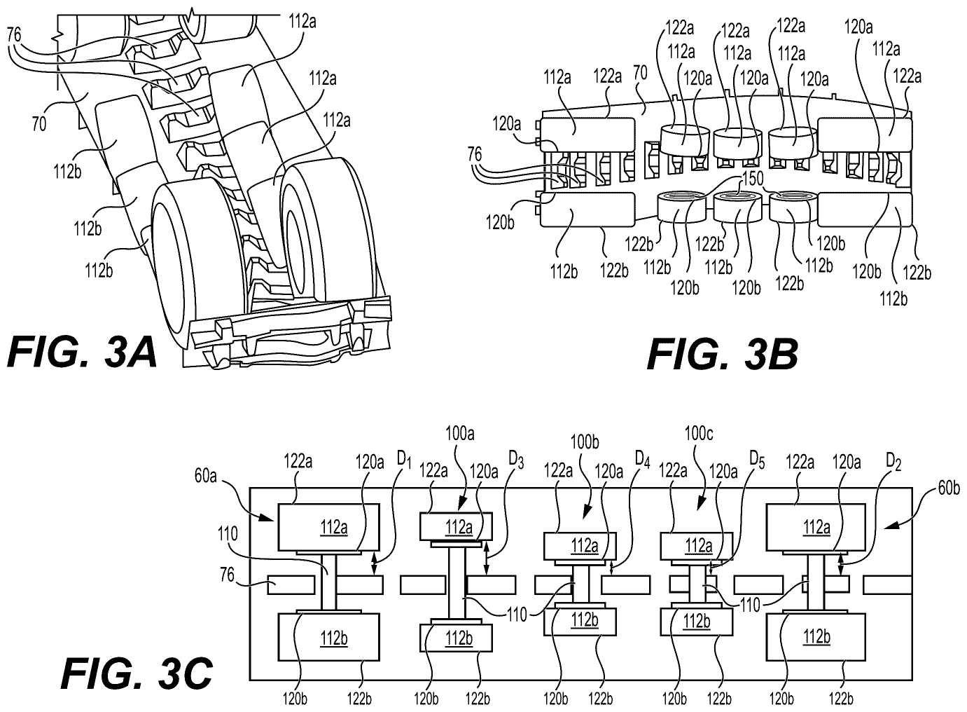

FIG. 3A is a perspective view taken from a top, front, right side of part of the track system of FIG. 2, with the endless track being laterally deformed;

FIG. 3B is a perspective view taken from a top of the part of the track system of FIG. 2 with the endless track being laterally deformed;

FIG. 3C is a schematic top plan view of the part of the track system of FIG. 2;

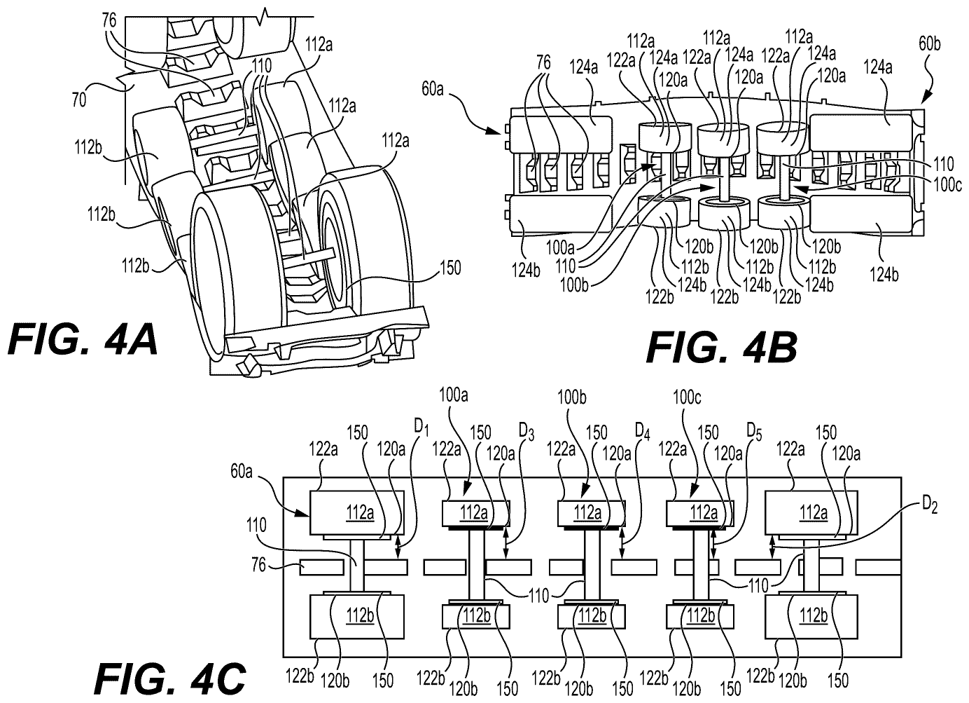

FIG. 4A is a perspective view taken from a top, front, right side of part of an alternative track system of FIG. 2, with the endless track being laterally deformed;

FIG. 4B is a perspective view taken from a top of the part of the track system of FIG. 4A, with the endless track being laterally deformed;

FIG. 4C is a schematic top plan view of the part of the track system of FIG. 4A, with the endless track not being deformed;

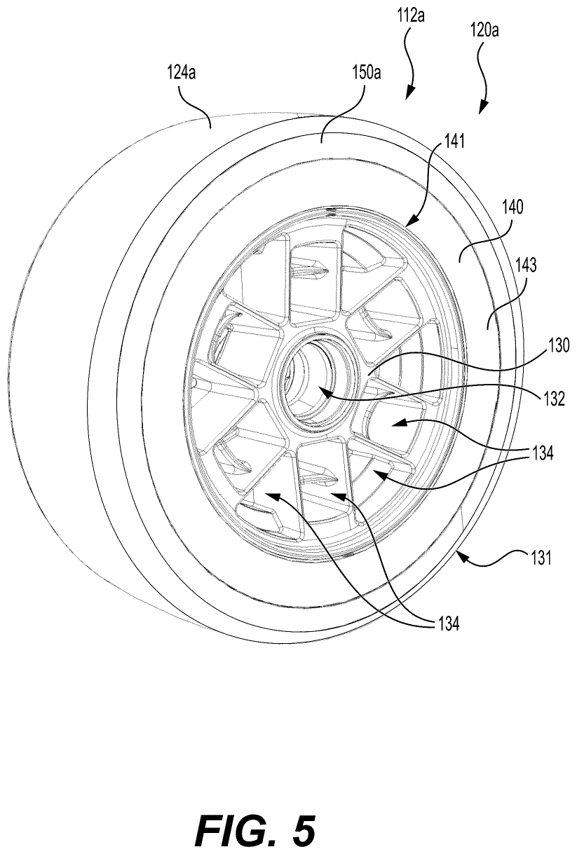

FIG. 5 is a perspective view taken from a top, front and right side of a wheel of the track system of FIG. 1 with a wear element according to an embodiment of the present technology;

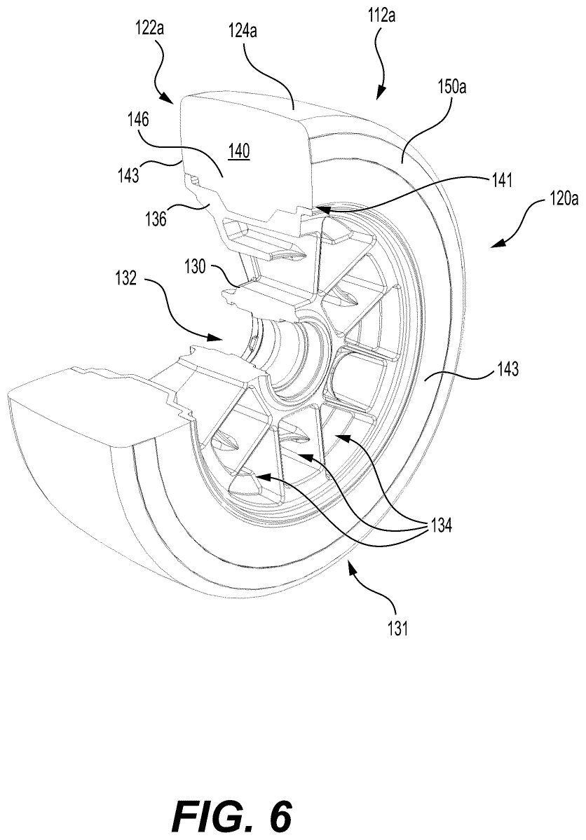

FIG. 6 is a partial section view taken from a top, front and right side of the wheel of FIG. 5 with a wear element according to an alternative embodiment of the present technology;

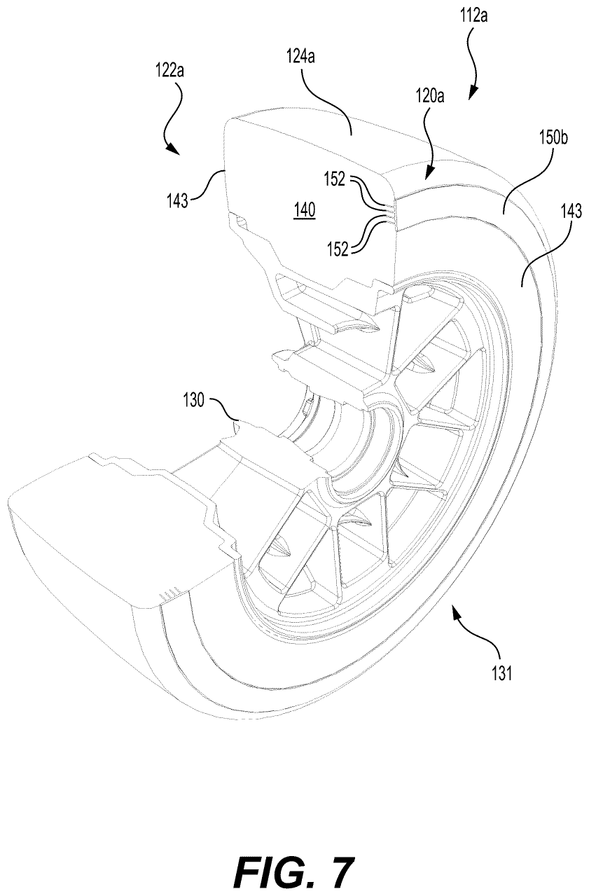

FIG. 7 is a partial section view taken from a top, front and right side of the wheel of FIG. 5 with a wear element according to an alternative embodiment of the present technology;

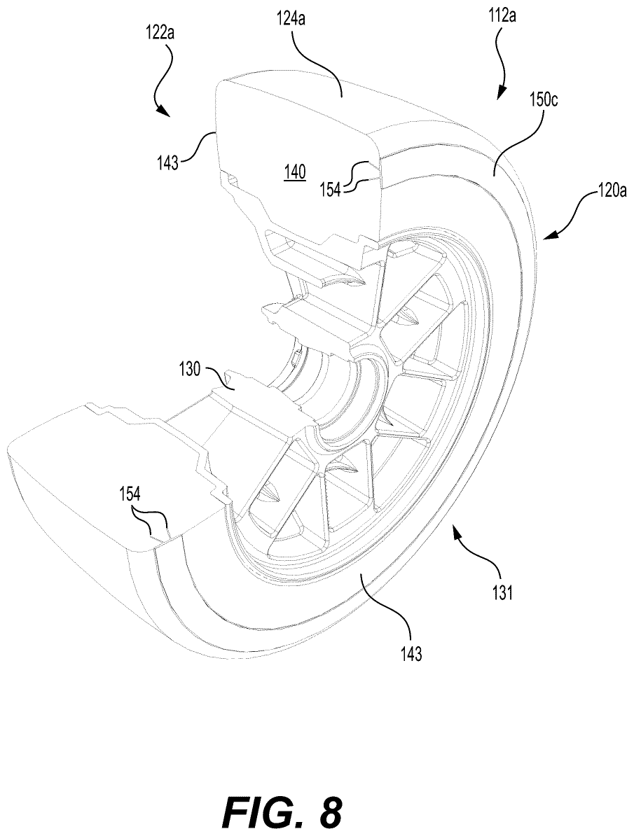

FIG. 8 is a partial section view taken from a top, front and right side of the wheel of FIG. 5 with a wear element according to an alternative embodiment of the present technology;

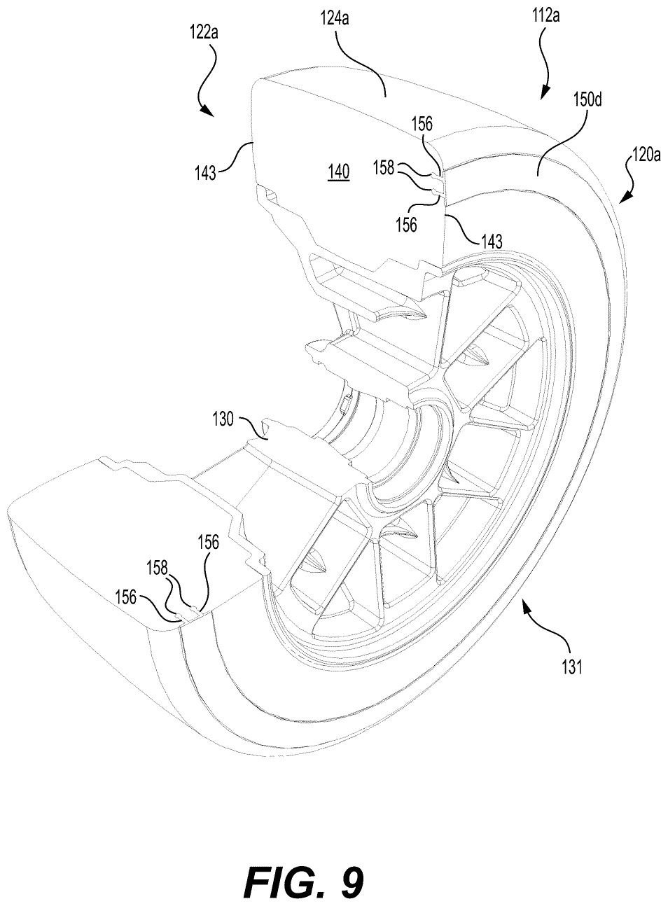

FIG. 9 is a partial section view taken from a top, front and right side of the wheel of FIG. 5 with a wear element according to an alternative embodiment of the present technology;

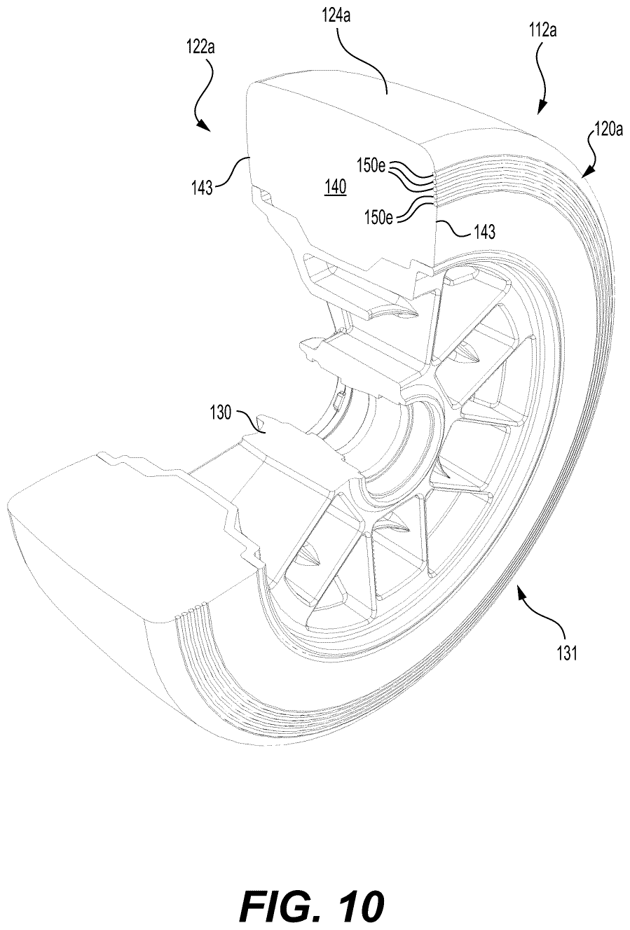

FIG. 10 is a partial section view taken from a top, front and right side of the wheel of FIG. 5 with wear elements according to an alternative embodiment of the present technology;

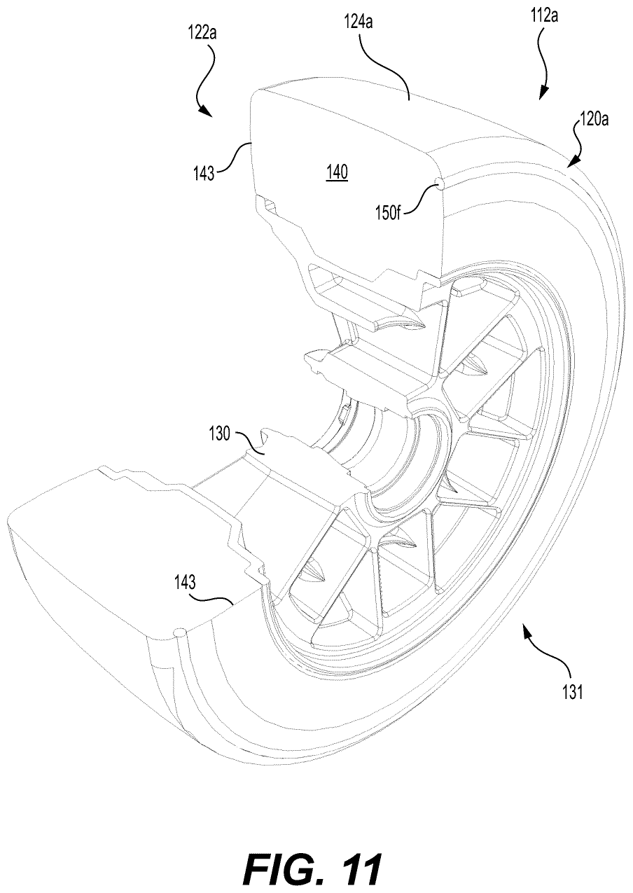

FIG. 11 is a partial section view taken from a top, front and right side of the wheel of FIG. 5 with a wear element according to an alternative embodiment of the present technology;

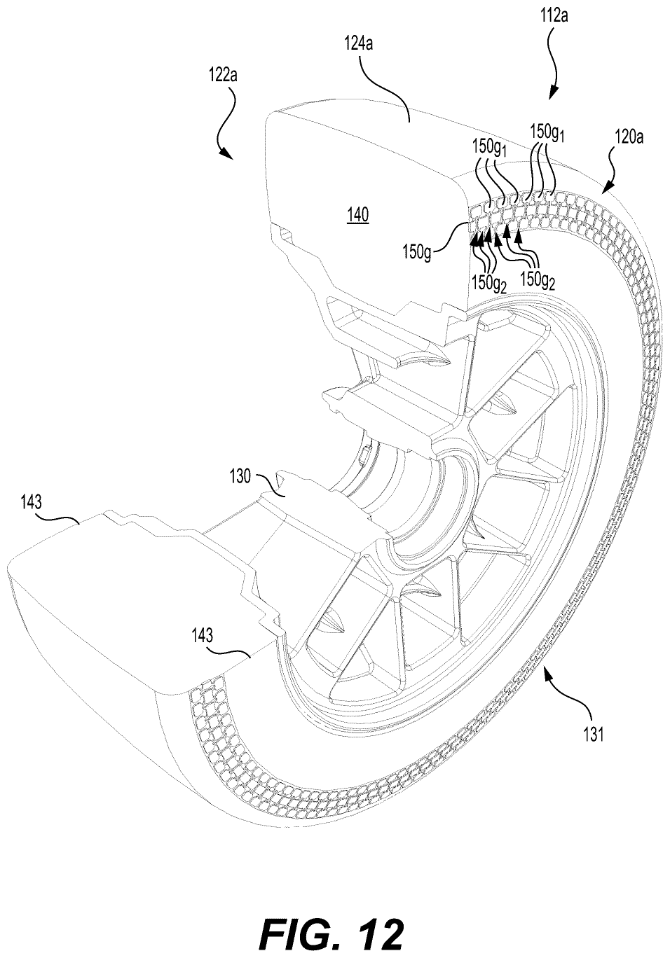

FIG. 12 is a partial section view taken from a top, front and right side of the wheel of FIG. 5 with a wear element according to an alternative embodiment of the present technology;

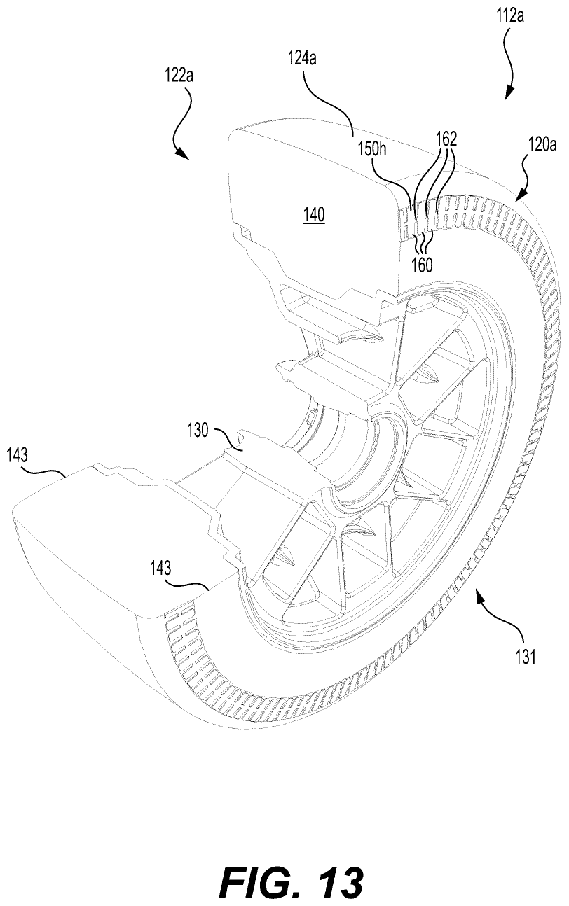

FIG. 13 is a partial section view taken from a top, front and right side of the wheel of FIG. 5 with a wear element according to an alternative embodiment of the present technology;

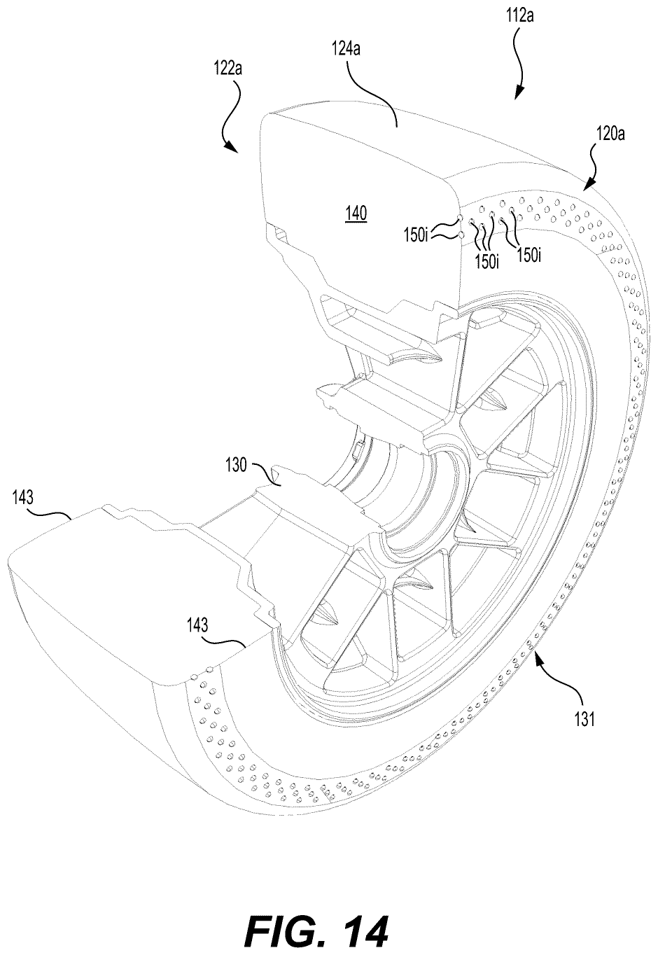

FIG. 14 is a partial section view taken from a top, front and right side of the wheel of FIG. 5 with wear elements according to an alternative embodiment of the present technology;

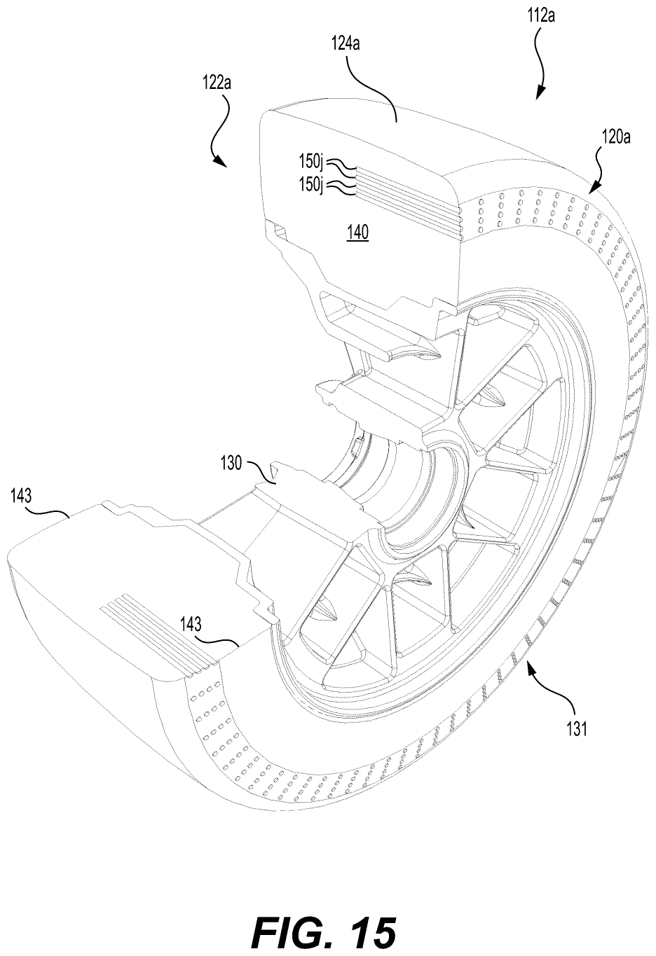

FIG. 15 is a partial section view taken from a top, front and right side of the wheel of FIG. 5 with wear elements according to an alternative embodiment of the present technology;

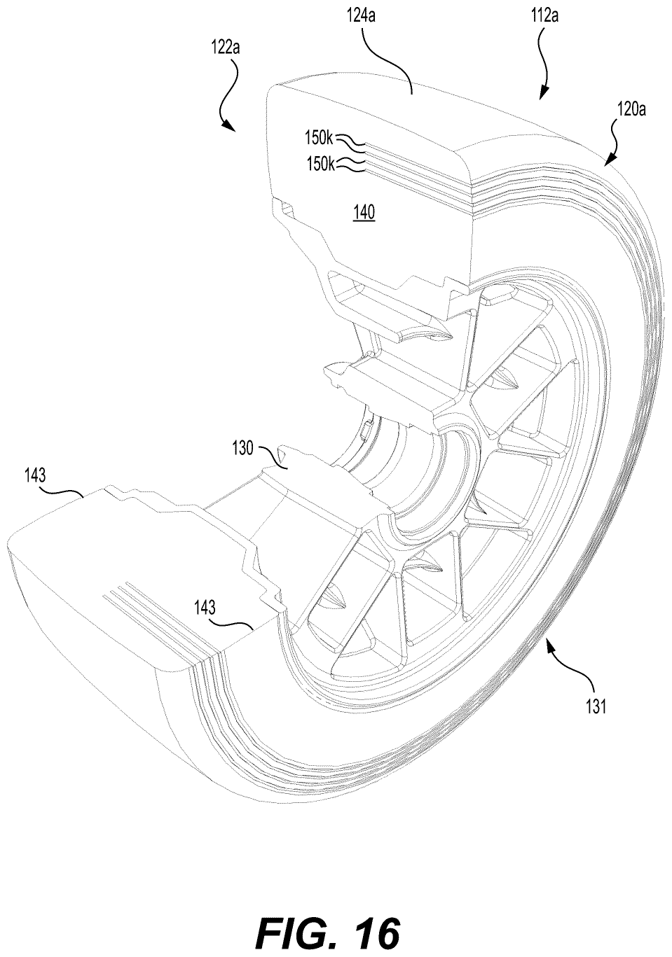

FIG. 16 is a partial section view taken from a top, front and right side of the wheel of FIG. 5 with wear elements according to an alternative embodiment of the present technology;

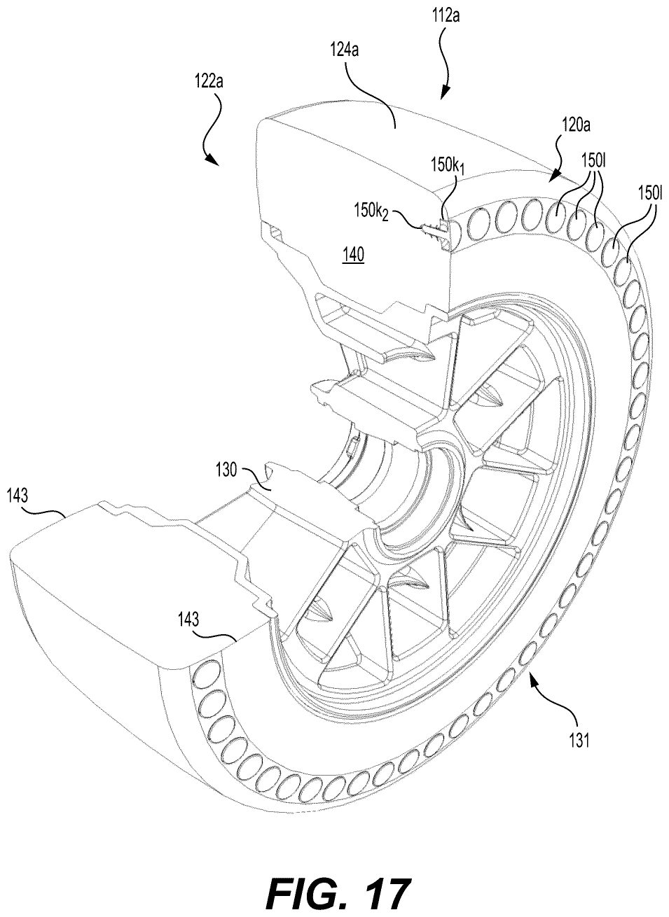

FIG. 17 is a partial section view taken from a top, front and right side of the wheel of FIG. 5 with wear elements according to an alternative embodiment of the present technology;

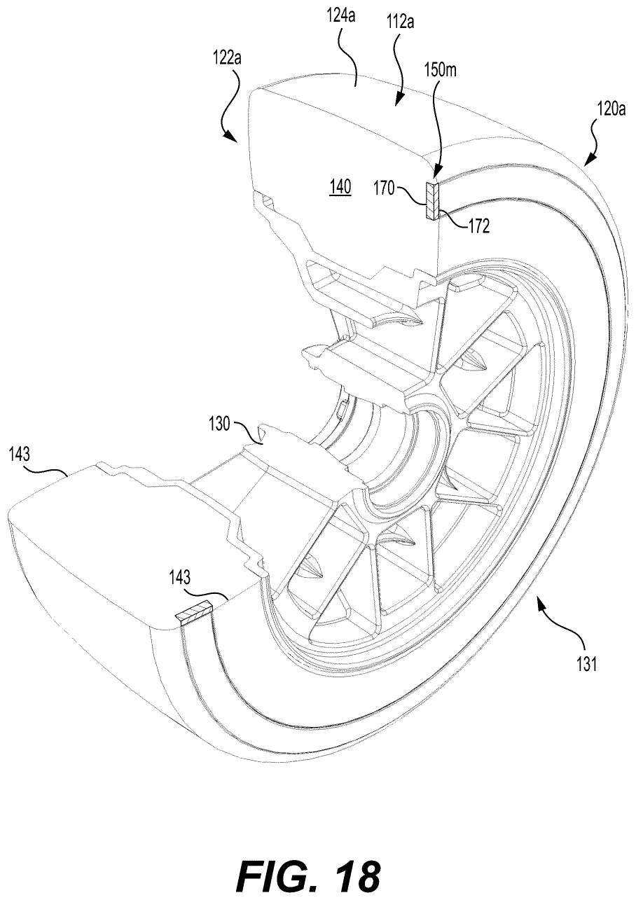

FIG. 18 is a partial section view taken from a top, front and right side of the wheel of FIG. 5 with a wear element according to an alternative embodiment of the present technology;

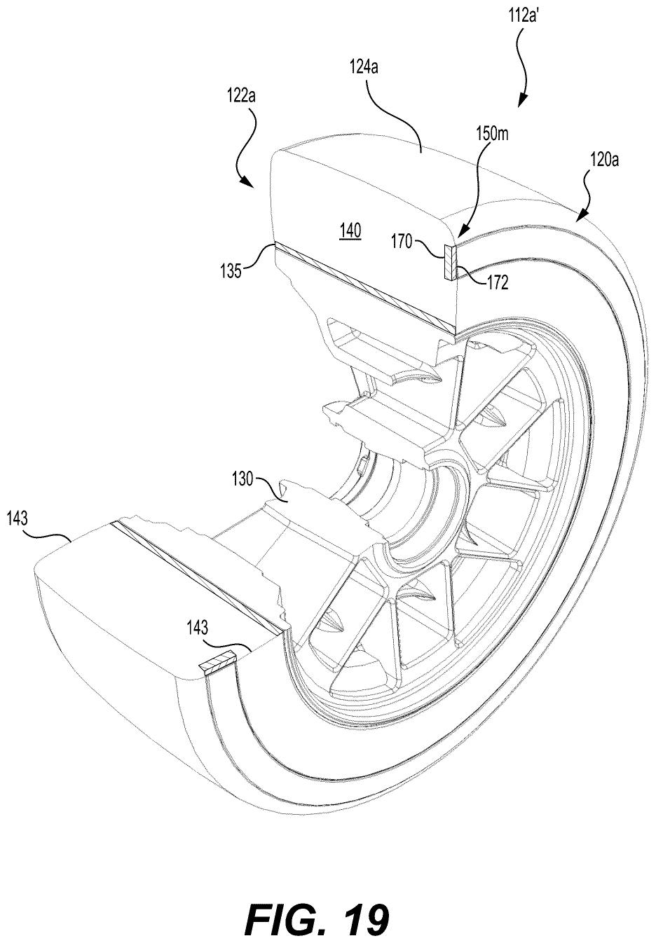

FIG. 19 is a partial section view taken from a top, front and right side of the wheel of FIG. 5 with a wear element according to an alternative embodiment of the present technology;

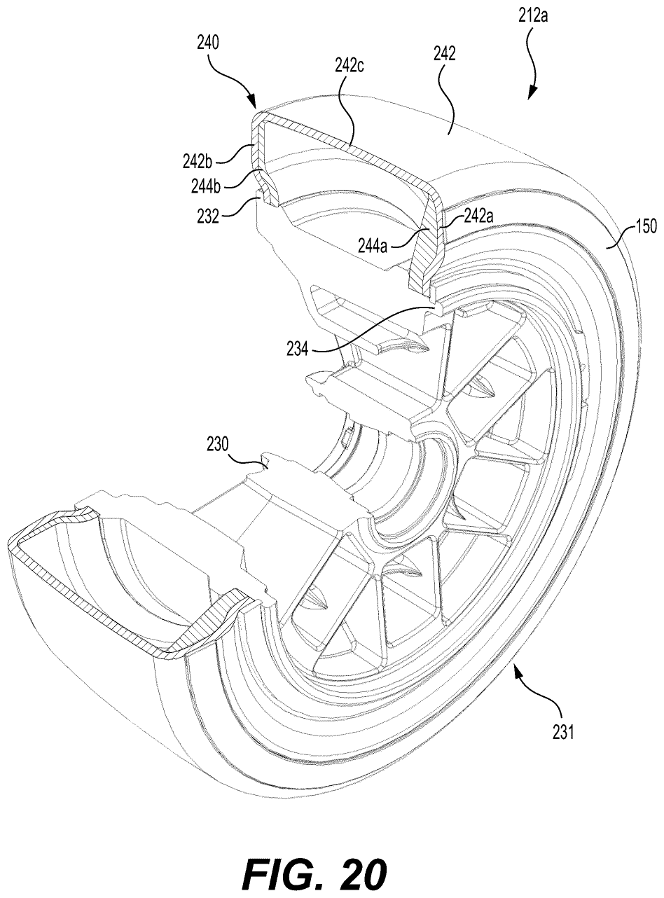

FIG. 20 is a partial section view taken from a top, front and right side of the wheel of FIG. 5 with a wear element according to an alternative embodiment of the present technology;

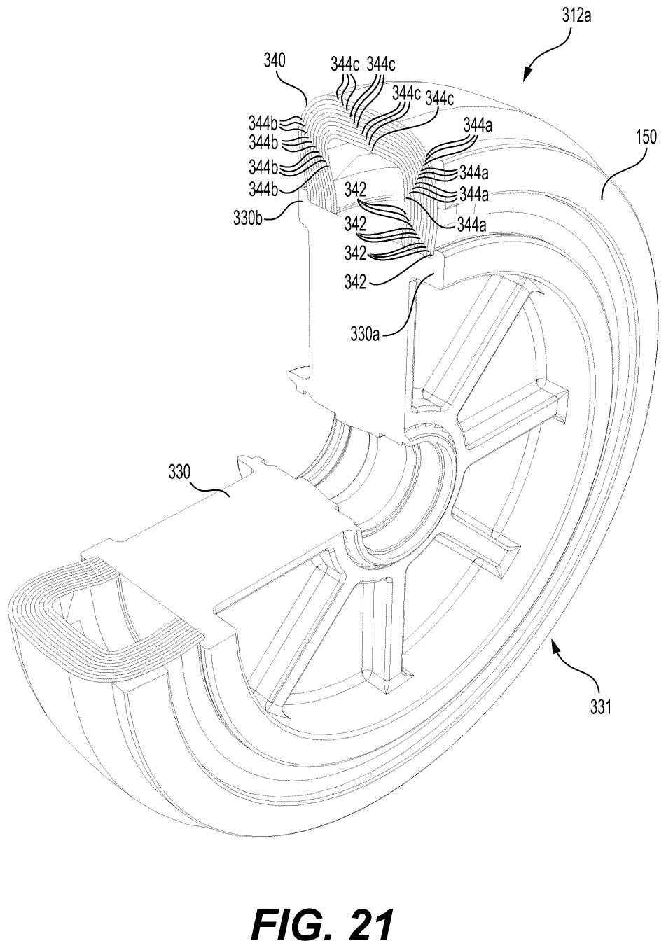

FIG. 21 is a partial section view taken from a top, front and right side of the wheel of FIG. 5 with a wear element according to an alternative embodiment of the present technology;

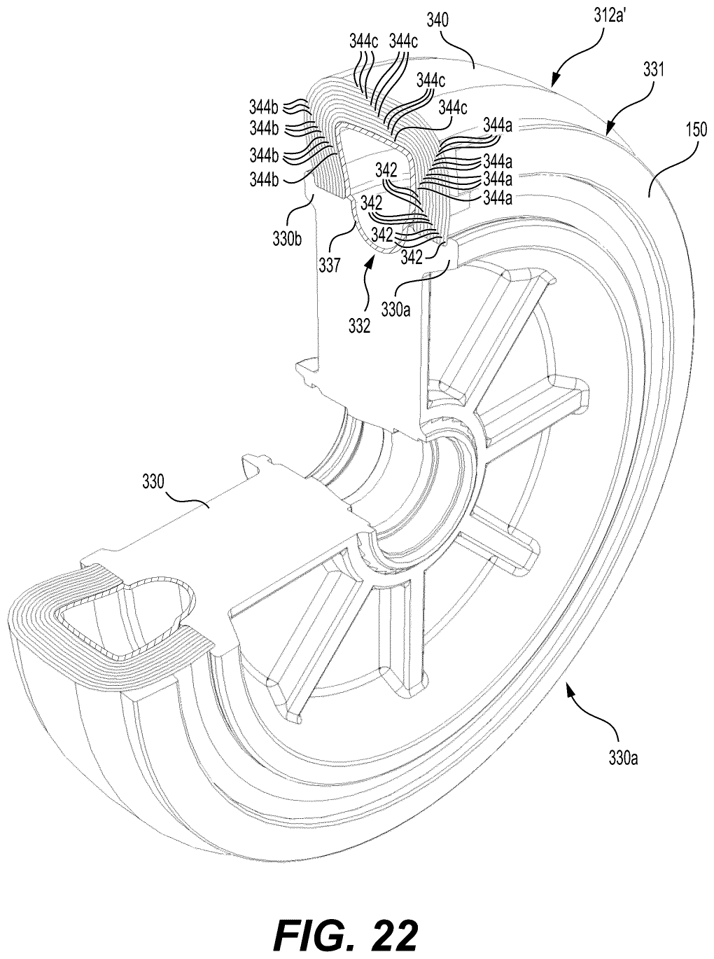

FIG. 22 is a partial section view taken from a top, front and right side of the wheel of FIG. 5 with a wear element according to an alternative embodiment of the present technology; and

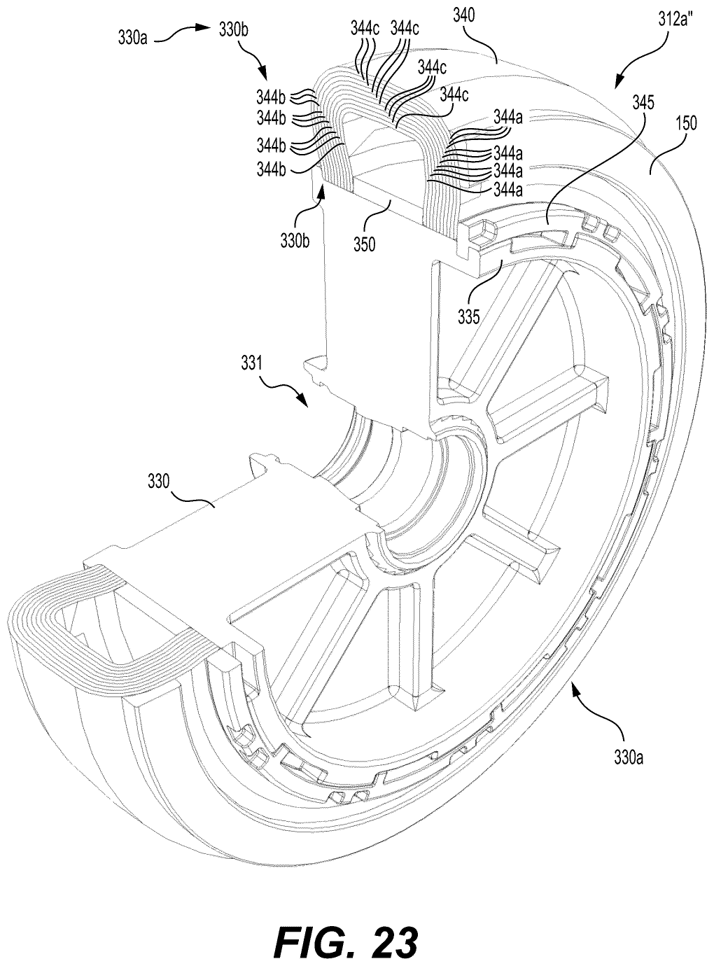

FIG. 23 is a partial section view taken from a top, front and right side of the wheel of FIG. 5 with a wear element according to an alternative embodiment of the present technology.

### DETAILED DESCRIPTION

### Off-Road Vehicle

Referring to FIG. 1, the present technology will be described with reference to a vehicle 10. The vehicle 10 is an off-road vehicle 10. More precisely, the vehicle 10 is an all-terrain vehicle (ATV) 10. It is contemplated that in other embodiments, the vehicle 10 could be another type of recreational vehicle such as a snowmobile, a side-by-side vehicle or a utility-task vehicle (UTV).

A person skilled in the art will understand that it is also contemplated that some aspects of the present technology in whole or in part could be applied to other types of vehicles such as, for example, agricultural vehicles, industrial vehicles, military vehicles or exploratory vehicles.

The vehicle 10 has two front track systems 20a (only the left one is shown in the accompanying Figures) in accordance with embodiments of the present technology, and two rear track systems 20b (only the left one is shown in the accompanying Figures) also in accordance with embodiments of the present technology. In some embodiments, the vehicle 10 could have more or fewer than four track systems.

The vehicle 10 includes a frame 12, a straddle seat 13 disposed on the frame 12, a powertrain 14 (shown schematically), a steering system 16, a suspension system 18, and the track systems 20a, 20b.

The powertrain 14, which is supported by the frame 12, is configured to generate power and transmit said power to the track systems 20a, 20b via driving axles, thereby driving the vehicle 10. More precisely, the front track systems 20a are operatively connected to a front axle 15a of the vehicle 10 and, the rear track systems 20b are operatively connected to a rear axle 15b of the vehicle 10. It is contemplated that in some embodiments, the powertrain 14 could be configured to provide its motive power to both the front and the rear axles 15a, 15b, to only the front axle 15a or to only the rear axle 15b (i.e., in some embodiments, the front axle and/or rear axle could be a driving axle). In some embodiments, the track systems 20a, 20b are operatively connected to non-driven axle of unpowered vehicles (e.g., trailer).

The steering system 16 is configured to enable an operator of the vehicle 10 to steer the vehicle 10. To this end, the steering system 16 includes a handlebar 17 that is operable by the operator to direct the vehicle 10 along a desired course. In other embodiments, the handlebar 17 could be replaced by another steering device such as, for instance, a steering wheel. The steering system 16 is configured so that in response to the operator handling the handlebar 17, an orientation of the front track systems 20a relative to the frame 12 is changed, thereby enabling the vehicle 10 to turn in a desired direction.

The suspension system 18, which is connected between the frame 12 and the track systems 20a, 20b allows relative motion between the frame 12 and the track systems 20a, 20b, and can enhance handling of the vehicle 10 by absorbing shocks and assisting in maintaining adequate traction between the track systems 20a, 20b and the ground.

The track systems 20a, 20b are configured to compensate for and/or otherwise adapt to the suspension system 18 of the vehicle 10. For instance, the track systems 20a, 20b are configured to compensate for and/or otherwise adapt to alignment settings, namely camber (i.e., a camber angle, “roll”), caster (i.e., a caster angle, “steering angle” and/or toe (i.e., a toe angle, “yaw”), which are implemented by the suspension system 18. As the vehicle 10 could have been originally designed to use wheels instead of the track systems, the alignment settings could originally have been set to optimize travel, handling, ride quality, etc. of the vehicle 10 with the use of wheels. Since the track systems 20a, 20b are structurally different and behave differently from wheels, the track system 20a, 20b may be configured to compensate for and/or otherwise adapt to the alignment settings to enhance their traction and/or other aspects of their performances and/or use.

### Track System

Referring now to FIG. 2, the track systems 20a, 20b will be described in greater detail. Being that the front and rear track systems 20a, 20b are similar, only the front left track system 20a will be described herewith.

The track system 20a includes a sprocket wheel assembly 40 which is operatively connectable to the driving axle 15a. The driving axle 15a is configured to drive the sprocket wheel assembly 40 in order to drive the track system 20a. The sprocket wheel assembly 40 defines laterally extending engaging members 44 (i.e., teeth) disposed on the circumference of the sprocket wheel assembly 40. The engaging members 44 are adapted, as will be described in greater detail below, to engage with lugs 76 provided on an inner surface 72 of an endless track 70 of the track system 20a. It is contemplated that in other embodiments, the configuration of the sprocket wheel assembly 40, and thus the manner in which the sprocket wheel assembly 40 engages the endless track 70, could differ without departing from the scope of the present technology.

The track system 20a further includes a frame 50. The frame 50 includes a leading frame member 52, a trailing frame member 54 and a lower frame member 56. The leading and trailing frame members 52, 54 are jointly connected around the driving axle 15a, the joint connection being positioned laterally outwardly from the sprocket wheel assembly 40. The leading frame member 52 extends forwardly and downwardly from the joint connection and connects to a forward portion of the lower frame member 56. The trailing frame member 54 extends rearwardly and downwardly from the joint connection and connects to a rearward portion of the lower frame member 56. The lower frame member 56, which is positioned below the joint connection, extends generally parallel to the forward direction of travel of the vehicle. In the present embodiment, the leading, trailing and lower frame members 52, 54, 56 are integral. It is contemplated that in other embodiments, the leading, trailing and lower frame members 52, 54, 56 could be distinct members connected to one another. It is contemplated that in other embodiments, the configuration of the frame 50 could differ without departing from the scope of the present technology. For instance, it is further contemplated that in some embodiments, the frame 50 could include more or less than three members. In some embodiments, one or more of the leading, trailing and lower frame members 52, 54, 56 could be pivotally connected to one another.

With continued reference to FIG. 2, the track system 20a further includes a leading idler wheel assembly 60a, a trailing idler wheel assembly 60b, and a plurality of support wheel assemblies 100a, 100b, 100c. In this embodiment, the track system 20a includes three support wheel assemblies, but it is contemplated that the track system 20a could include more or fewer than three support wheel assemblies. Each of the leading and trailing idler wheel assemblies 60a, 60b and the support structures 100a, 100b, 100c includes two laterally spaced wheels 112a, 112b. It is contemplated that in some embodiments, at least one of the leading and trailing idler wheel assemblies 60a, 60b, and the support wheel assemblies 100a, 100b, 100c could have a single wheel, or three or more laterally spaced wheels.

The leading idler wheel assembly 60a is rotationally connected to a leading end of the lower frame member 56, the trailing idler wheel assembly 60b is rotationally connected to a trailing end of the lower frame member 56, and the support wheel assemblies 100a, 100b, 100c, which will be described in greater detail below, are connected to the lower frame member 56 longitudinally between the leading and trailing idler wheel assemblies 60a, 60b.

In some embodiments, at least one of the leading and trailing idler wheel assemblies 60a, 60b could be connected to the lower frame member 56 via a tensioner (not shown), where the tensioner is operable to adjust the tension in the endless track 70 by selectively moving the at least one of the leading and trailing idler wheel assemblies 60a, 60b toward or away from the frame 50.

The track system 20a also includes the endless track 70, which extends around components of the track system 20a, notably the frame 50, the leading and trailing idler wheel assemblies 60a, 60b and the support wheel assemblies 100a, 100b, 100c. The endless track 70 has the inner surface 72 and an outer surface 74. The inner surface 72 of endless track 70 has lugs 76 (shown in FIGS. 2, 4A and 4B). The lugs 76 are adapted to engage with the engaging members 44 of the sprocket wheel assembly 40. As previously mentioned, other engagement configurations between the sprocket wheel assembly 40 and the endless track 70 are contemplated. The outer surface 74 of the endless track 70 has a tread defined thereon. It is contemplated that the tread could vary from one embodiment to another. In some embodiments, the tread could depend on the type of vehicle 10 on which the track system 20a is to be used and/or the type of ground surface on which the vehicle 10 is destined to travel. In the present embodiment, the endless track 70 is an elastomeric endless track. Specifically, the endless track 70 is a polymeric endless track.

### Idler and Support Wheel Assemblies

With reference to FIGS. 3A, 3B, 4A, 4B and 5 to 16, the idler and support wheel assemblies 60a, 60b, 100a, 100b, 100c will now be described in greater detail. In one embodiment, the idler and support wheel assemblies 60, 60b, 100a, 100b, 100c are all pivotally connected to the frame 50. In other embodiments, one or more of the idler and support wheel assemblies 60, 60b, 100a, 100b, 100c could be rotationally connected to the frame 50 in other embodiments. The idler and support wheel assemblies 60a, 60b, 100a, 100b, 100c are generally similar, and thus, only the idler wheel assembly 60a will be described in greater detail.

The support wheel assembly 60a includes a shaft 110 as well as two wheels: a left wheel 112a, and a right wheel 112b. The shaft 110, which is connected to the left and right wheels 112a, 112b, is also connected to the lower frame member 56. In some embodiments, the shaft 110 is rotationally connected to the lower frame member 56 via a bearing. In other embodiments, the shaft 110 is pivotally connected to the lower frame member 56 by a pivoting assembly. In a resting configuration of the track system 20a, the shaft 110 extends laterally relative to the frame 50. The left wheel 112a is disposed on a left side of the lugs 76, and the right wheel 112b is disposed on a right side of the lugs 76. Being that the lugs 76 are generally disposed at a center of the track system 20a, the left and right wheels 112a, 112b can be considered to be, respectively, on a left side and a right side of a longitudinal center plane of the track system 20a (i.e., laterally outwardly from the lugs 76). Other configurations are contemplated as well. For example, in an embodiment where there are two or more laterally spaced sets of longitudinally spaced lugs, the left wheel 112a could be disposed on a right side of a first set of longitudinally space lugs, and the right wheel 112a could be disposed on a left side of a second set of longitudinally space lugs.

As will be described in greater detail below, in one aspect of the present technology, the shaft 110 of the front and rear idler wheel assemblies 60a, 60b is sized so that the wheels 112a, 112b connected thereto are closer to the lugs 76 than the wheels 112a, 112b of the support wheel assemblies 100a, 100b, 100c. Specifically, the wheels 112a, 112b of the support wheel assemblies 100a, 100b, 110c are laterally spaced from lugs 76 by a distance that is greater than is conventional in track systems. As will be described in greater detail below, this can assist in reducing wear of the wheels 112a, 112b of the support wheel assemblies 100a, 100b, 100c and the lugs 76.

### Wheels

The wheels 112a, 112b will now be described in greater detail. It is understood that each one of idler and support wheel assemblies 60a, 60b, 100a, 100b, 100c includes the wheels 112a, 112b. Thus, the wheels 112a, 112b can be considered to be a support wheel and/or an idler wheel. In some embodiments, as will be described below, one or more of the idler and support wheel assemblies 60a, 60b, 100a, 100b, 100c could include a different wheel.

The wheels 112a, 112b are resiliently deformable, notably in the radial direction. The wheels 112a, 112b are sometimes referred to as resilient wheels and/or flexible wheels. The wheels 112a, 112b being resiliently deformable provide various advantages. For instance, removal of debris such as snow, ice and/or soil that may, during operation, accumulate on the wheels 112a, 112b, can be facilitated. More specifically, deformation of the wheels 112a, 112b can prevent debris such as snow, ice and/or soil from adhering to the wheels 112a, 112b (build-up). Furthermore, the wheels 112a, 112b being deformable can assist in absorbing shocks and impacts felt by the track system 20a, which can improve ride-quality.

In some embodiments, the wheels 112a, 112b are non-pneumatic wheels. One advantage of non-pneumatic resilient wheels is that they can provide a wheel with increased durability and increased resistance compared to conventional tires. Indeed, the wheels 112a, 112b can be less prone to puncture. In some implementations of the present technology, however, the wheels 112a, 112b could be pneumatic wheels.

The wheel 112a has an inner side 120a that is oriented towards the lugs 76, and an outer side 122a that is oriented away from the lugs 76. Likewise, the wheel 112b has an inner side 120b that is oriented towards the lugs 76, and an outer side 122b that is oriented away from the lugs 76. In other words, the inner sides 120a, 120b of the wheels 112a, 112b are closer to the longitudinal center plane of the track system 20a than their corresponding outer sides 122a, 122b. The wheel 112a has, extending laterally between the inner and outer sides 120a, 122a, a peripheral surface 124a that is configured to engage the inner surface 72 of the endless track 70. Similarly, the wheel 112b has, extending laterally between the inner and outer sides 120b, 122b, a peripheral surface 124b that is configured to engage the inner surface 72 of the endless track 70. It is contemplated that in some embodiments, for example, where the endless track 70 has two laterally spaced sets of longitudinally spaced lugs, it is the outer sides 120b, 122b that may be oriented towards the lugs.

Now referring to FIGS. 5 and 6, the wheels 112a, 112b will now be described. As the wheels 112a, 112b are similar, only the wheel 112a will be described in detail herewith. The wheel 112a, which is a non-pneumatic wheel 112a, has a hub component 130 and a resilient component 131, which includes a resilient body 140 and at least one wear element 150. In some embodiments, the resilient body 140 and the wear element 150 could be considered to be separate components, such that a wheel could include a hub component, a resilient component and a wear component. The hub component 130 and the resilient body 140 are configured to connect to one another. It is contemplated that the hub component and the resilient body 140 can be connected to one another in a variety of ways, such as by a mechanical interlock, by chemical bonds and/or by overmolding. It is to be noted that the connection between the hub component 130 and the resilient body 140 is configured to be provide a seal therebetween.

The hub component 130 is made of a rigid material, and defines a central aperture 132 that is configured to receive at least part of the shaft 110 therein. In some embodiments, the central aperture 132 could be configured to receive one or more bearing therein. The hub component 130 also defines a plurality of apertures 134. The plurality of apertures 134 can assist in reducing the amount of material required to manufacture the hub component 130, which, in turn, can reduce weight thereof, as well as reduce costs for manufacturing the hub component 130. In some embodiments, the apertures 134 could be recesses. In other embodiments, the apertures 134 could be omitted. On a peripheral surface of the hub component 130, the hub component 130 has a connecting feature 136 (FIG. 6), sometimes referred to as a connector. More specifically, in this embodiment, the connecting feature 136 is a recess. In other embodiments, the connecting feature 136 could be a protrusion. As will be described below, the connecting feature 136 is configured to connect to a complimentary connecting feature 146 of the resilient body 140. In some embodiments, the hub component 130 could have lips thereon for providing a sealed junction between the hub component 130 and the resilient body 140.

The resilient body 140 is resiliently deformable. The resilient body 140 has an annular shape, and defines a hub aperture 141 that is sized and configured to receive the hub component 130 therein. In some embodiments, the hub aperture 141 defined by the resilient body 140 could be sized and configured to have an interference fit with the hub component 130. Thus, in some embodiments, the wheel 112a is assembled by stretching the resilient body 140 (e.g., stretching on a cone) over the hub component 130. In such embodiments, the hub component 130 would define a first radius, the hub aperture 141 would define a second radius, and the second radius being at least partially smaller than the first radius. The resilient body 140 also has the connecting feature 146 disposed on a radial inner side, which is complementary to the connecting feature 136. The connecting features 136, 146 can provide a mechanical interlock between the hub component 130 and the resilient body 140, which can assist in enhancing connection therebetween such that the resilient body 140 is less likely from disconnecting from the hub component 130. Extending radially outwardly from the hub aperture 141, the resilient body 140 has lateral sidewalls 143. Furthermore, the resilient body 140 is made of a material that has a relatively low coefficient of friction with the material of the endless track 70, but not so low so that the resilient body 140 would slip on the endless track 70. In some implementations, the resilient body 140 is made of a resilient material such as, but not limited to, a foam. In some embodiments, the foam is a closed cell foam. In some embodiments, the resilient body 140 is made of a polyurethane closed cell foam.

The wear element 150 is connected to the resilient body 140. More specifically, the wear element 150 is connected to one of the sidewalls of the wear element 150 (i.e., to the side 120a of the wheel 112a). The wear element, which is configured to reduce wear of the resilient body 140 and to reduce wear of the lugs 76, will be described in greater detail below.

Referring to FIG. 20, an alternative embodiment of the wheel 112a, namely wheel 212a, will be described. It is understood that the right wheel 112b has a corresponding wheel (not shown in accompanying figures) that is similar to the wheel 212a.

The wheel 212a is resiliently deformable, notably in the radial direction. The wheel 212 has a hub component 230, and a resilient component 231 including: a resilient body 240, a retaining ring 245 and the at least one wear element 150.

Features of the hub component 230 similar to those of the hub component 130 will not be described in detail herewith again. The hub component 230 has an abutting portion 232 that is configured to engage with part of the resilient body 240. In some embodiments, the abutting portion 230 could define channels for receiving parts of the resilient body 240 therein. The hub component 230 further has a locking portion 234, which, as will be described below, is configured to engage with the retaining ring 245 to lock the resilient body 240 to the hub component 230.

The resilient body 240, which can be referred to as a tire, has an outer membrane 242, and an inner membranes 244a, 244b. The outer membrane 242 has a lateral side 242a (sometimes referred to as a sidewall) that extends in the radial direction, a lateral side 242b (sometimes referred to as a sidewall) that also extends in the radial direction, and a peripheral side 242c that extends laterally between the lateral sides 242a, 242b. In some embodiments, the resilient body 240 could include a low-density foam. In some instances, the foam could be connected to the peripheral side 242c to reduce chances of puncture.

The inner membrane 244a is connected to the lateral side 242a of the outer membrane 242, and the inner membrane 244b is connected to the lateral side 242b of the outer membrane 242. The presence of the inner membranes 244a, 244b assists in reinforcing the outer membrane 242, such that when a load is applied to the wheel 212a (e.g., part of a weight of a vehicle), the presence of the inner membranes 244a, 244b reduces deformation that the resilient body 240 would undergo compared to if the inner membranes 244a, 244b were to be omitted. The wheel 212a, due to the presence of the inner membranes 244a, 244b, does not need to be a pneumatic wheel. Indeed, in some embodiments, the inner membranes 244a, 244b provide sufficient rigidity to the wheel 340 so that the wheel 212a can sustain a given load without undergoing undue deformation. The presence of a low-density foam, or another material which could prevent debris from entering into the chamber defined by the hub component 230 and the resilient body 240 if a puncture were to happen to the outer membrane 242.

The resilient body 240 is connectable to the hub component 230. The resilient body 240 can be connected to the hub component 230 by sliding the resilient body 240 over the hub component 230 until one of the lateral sides 242a, 242b engages the abutting portion 230. Then the other one of the lateral sides 242a, 242 is slid over the locking portion 234. The retaining ring 245 is then disposed laterally between the outer membrane 242 and the locking portion 234. The retaining ring 245 retains the resilient body 240 to the hub component 230. In some embodiments, the use of the retaining ring 245 can facilitate connection and disconnection of the resilient body 240 from the hub component 230.

Referring to FIG. 21, an alternative embodiment of the wheels 112a, 212a, namely wheel 312a, will now be described. It is understood that the right wheel 112b has a corresponding wheel (not shown in accompanying figures) that is similar to the wheel 312a.

The wheel 312a is resiliently deformable, notably in the radial direction. The wheel 312a has a hub component 330, and a resilient component 331 including: a resilient body 340 and the at least one wear element 150.

Features of the hub component 330 similar to those of the hub component 130 will not be described in detail again. The hub component 330 has abutting portions 330a, 330b that are configured to abut the resilient body 340.

The resilient body 340 includes a plurality of strengthening folds 342. In some embodiments, there could be ten strengthening folds 342. In other embodiments, there could be twenty strengthening folds 342. It is contemplated that there could be more or fewer strengthening folds in other embodiments. In some embodiments, the number of strengthening folds 342 can vary according to the vehicle that the wheel 312a is destined to be used with (i.e., a heavier vehicle may utilize a resilient body with a greater number of strengthening folds than a lighter vehicle). Each one of the strengthening folds 342 has a lateral side 344a, a lateral side 344b and a peripheral side 344c extending between the lateral sides 344a, 344b. The strengthening folds 342 vary in size from one to another. The strengthening folds 342 reinforce the resilient body 340. The wheel 312a, due to the presence of the plurality of strengthening folds 342, does not necessarily need to be a pneumatic wheel. Indeed, in some embodiments, the plurality of strengthening folds 342 provides sufficient rigidity to the resilient body 340 so that the wheel 312a can sustain a given load without undergoing undue deformation.

The resilient body 340 is configured to be connected to the hub component 330 by an interference fit. When connected to one another, the lateral side 344a is configured to abut the abutting portion 330a, and the lateral side 344b is configured to abut the abutting portion 330b. In some instances, being that the hub component 330 does not have to accommodate for a retaining ring, the resilient body 340 can be larger than the resilient body 240, which can assist in reducing pressure applied on the endless track 70.

With reference to FIG. 22, an alternative embodiment of the wheel 312a, namely wheel 312a′ is shown. The wheel 312a′ is similar to the wheel 312. The wheel 312a′ notably differs from the wheel 312 in that the hub component 330 of the wheel 312a′ has a positioning feature 332. In the illustrated embodiment, the positioning feature 332 is a recess. It is contemplated that in other embodiments, the positioning feature 332 could be a protrusion.

Furthermore, in this embodiment, the resilient component 331 further includes a positioning element 337. The positioning element 337, which is connected to an innermost fold 342, is at least partially complementary to the positioning feature 332 of the hub component 330. In some embodiments, the positioning element 337 is part of the resilient body 340. The positioning element 337 can be a pneumatic chamber. In some embodiments, the positioning element 337 is made of rubber. The positioning element 337 can assist in positioning the resilient component 331 relative to the hub component 330.

With reference to FIG. 23, an alternative embodiment of the wheel 312a, namely wheel 312a″ is shown. The wheel 312a″ is similar to the wheel 312a. The wheel 312a″ notably differs from the wheel 312a in that the wheel 312a′ further includes an axial member 350 and a retaining ring 345, and in that the hub component 330 has a retaining portion 335.

The axial member 350 is configured to abut the lateral sides 344a, 344b of the innermost strengthening fold 342. Furthermore, the axial member 350 is also configured to abut a peripheral surface of the hub component 330, upon connection of the wheel 312a. In some embodiments, the axial member 250 is part of the hub component 330.

The retaining ring 345 and the retaining portion 335 are engageable with one another. In some embodiments, the retaining ring 345 and the retaining portion 335 are a twist and lock mechanism.

During assembly, the retaining ring 345 is axially pressed against the hub component 330 and the resilient body 340 to ensure that the various parts of the wheel 312a″ are snug with one another. The axial member 340 can assist in assuring that the resilient body 340 does not move laterally while the retaining ring 345 is pressed thereon. In some embodiments, the axial member 350 can be used without the retaining ring 345 and vice-versa.

### Wear Element

Referring back to FIGS. 6 to 19, various embodiments of the wear element 150, which as mentioned above is configured to reduce wear of the resilient body 140 and wear of the lugs 76, will now be described. Although the wear element 150 will be described with reference to the wheel 112a, it is understood that the wear element 150 could be used with the wheels 212a, 312a, 312a′, 312a″.

The wear element 150 is connected to the sidewall 143 of the resilient body 140 of the wheel 112a, at the lateral side of the wheel 112a that is facing the lugs 76. In some embodiments, the wear element 150 could be selectively connected to the resilient body 140, such that it could easily be replaced. For example, when the lugs 76 are centered on the inner surface 72 of the endless track 70 with wheels 112a, 112b being disposed laterally outwardly from the lugs 76, the wear element 150 is connected at the inner side 120a of the resilient body 140 of the wheels 112a, 112b. In another example, when the lugs 76 are disposed on the inner surface of the endless track 70 and facing outer sides 122a, 122b of the wheels 112a, 112b, the wear element 150 would be connected at the outer sides 122a, 122b of the resilient body 140 of the wheels 112a, 112b. The wear element 150 at least partially extends out of the resilient body 140, such that it would contact the lugs 76 before the resilient body 140. The wear element 150 can be overmolded, bonded, mechanically interlocked, for example, or a combination of these methods, to the resilient body 140. In some instances, the wear element 150 can be permanently connected to the resilient body 140.

The wear element 150 is configured to be flexible to avoid impeding the deformable nature of the wheel 112a. More specifically, in some embodiments of the present technology, the wear element 150 is configured to be flexible to avoid impeding the resilient and deformable nature of the resilient body 140. In some embodiments, the wear element 150 is configured such that when the resilient body 140 is connected to the wear element 150, the resilient body 140 has a first modulus of elasticity, and when the resilient body 140 is disconnected from the wear element 150, the resilient body 140 has a second modulus of elasticity, where the first and second modulus of elasticity are generally similar. As will be described below, this can be achieved in a variety of ways such as: making the wear element 150 out of a resiliently deformable material, making the wear element 150 with a thin cross-sectional area allowing for a radial deformation, or the like. The wear element 150 is made of a wear-resistant material with a low coefficient of friction (e.g., ultra-high-molecular-weight polyethylene (UHMW-PE)).

Broadly, during operation of the track system 20a, the endless track 70 can move relative to the idler and support wheel assemblies 60a, 60b, 100a, 100b, 100c. In some instances, in response to the endless track 70 moving laterally by a given amount, the inner side 120a, 120b of one of the wheels 112a, 112b can engage the lugs 76. This engagement would cause wear to the one of the wheels 112a, 112b and the endless track 70 if the wear element 150 were not present. According to an aspect of the present technology, however, the wear element 150 is configured to wear out, thereby reducing wear that the lugs 76 and the wheels 112a, 112b are subjected to.

With reference to FIGS. 5 and 6, a first embodiment of the wear element 150, namely wear element 150a, will now be described. The wear element 150a is a continuous band 150a that is integrated into the resilient body 140. The continuous band 150a has a lateral thickness of about 1 mm to 5 mm and a radial thickness of about 1 mm to 5 mm. It is contemplated that the lateral and radial thicknesses of the continuous band 150a could vary to some extent, so long as the continuous band 150a can deform with the resilient body 140. In other words, the wear element 150a is resiliently deformable, such that the continuous band 150a does not impede deformation of the wheel 112a. The continuous band 150a surrounds the hub aperture 141. It is contemplated in some embodiments, that the wear element 150a could be segmented, with gaps being present between adjacent segments. It is further contemplated that in some embodiments, the continuous band 150a could only partially surround the hub aperture 141.

With reference to FIG. 7, a second embodiment of the wear element 150, namely wear element 150b, will now be described. The wear element 150b is similar to the wear element 150a. The wear element 150b notably differs from the wear element 150a in that the wear element 150b has inner protrusions 152 that extend axially toward the interior of the wheel 112 (i.e., extend in the resilient body 140). In some embodiments, the inner protrusions 152 extend axially by about 0.5 mm. In other embodiments, the inner protrusions 152 extend axially by about 1 mm. In the present embodiment, the wear element 150b has four inner protrusions 152. It is contemplated that in other embodiments, there could be more or fewer inner protrusions 152. The inner protrusions 152 increase contact surface between the wear element 150b and the resilient body 140, which can improve the overall anchoring of the wear element 150b to the resilient body 140. Thus, in some instances, the inner protrusions 152 can be referred to as anchors or anchoring members. Also, in some cases, the inner protrusions 152 can act as a heat sink, such that the heat generated by friction between the wear element 150b and the endless track 70 can be dissipated, at least partially, within the resilient body 140. This can assist in extending the life of the wear element 150b. In the present embodiment, the inner protrusions 152 extend along an entire circumference of the wear element 150b. It is contemplated, however that there could be a plurality of inner protrusions 152 circumferentially spaced from one another. Although the wear element 150b is illustrated as being a continuous component, it is contemplated that in some instances, the wear element 150b could be made of various segments with gaps between adjacent segments.

With reference to FIG. 8, a third embodiment of the wear element 150, namely wear element 150c, will now be described. The wear element 150c is similar to the wear element 150a. The wear element 150c notably differs from the wear element 150a in that the wear element 150c has inner protrusions 154 that extend axially and radially (i.e., at and angle), toward the interior of the wheel 112 (i.e., extend in the resilient body 140). In the present embodiment, the wear element 150c has two inner protrusions 154. It is contemplated that in other embodiments, there could be more or fewer inner protrusions 154. The inner protrusions 154 increase contact surface between the wear element 150c and the resilient body 140, which can improve the overall anchoring of the wear element 150c to the resilient body 140. Thus, in some instances, the inner protrusions 154 can be referred to as anchors or anchoring members. It is to be noted that the angled configuration of the inner protrusions 154 can further assist in anchoring the wear element 150c by providing a mechanical interlock when compared with the inner protrusions 152 of the wear element 150b. Also, in some cases, the inner protrusions 154 can act as a heat sink, such that the heat generated by friction between the wear element 150c and the endless track 70 can be dissipated at least partially within the resilient body 140. This can assist in extending the life of the wear element 150b. In the present embodiment, the inner protrusions 154 extend along an entire circumference of the wear element 150c. It is contemplated, however that there could be a plurality of inner protrusions 154 circumferentially spaced from one another. Although the wear element 150c is illustrated as being a continuous component, it is contemplated that in some instances, the wear element 150c could be made of various segments with gaps between adjacent segments.

With reference to FIG. 9, a fourth embodiment of the wear element 150, namely wear element 150d, will now be described. The wear element 150d is similar to the wear element 150a. The wear element 150d notably differs from the wear element 150a in that the wear element 150d has inner protrusions 156 that have enlarged portions 158. The inner protrusions 156 extend axially toward the interior of the wheel 112 (i.e., extending in the resilient body 140). In the present embodiment, the wear element 150d has two inner protrusions 156. It is contemplated that in other embodiments, there could be more or fewer inner protrusions 156. The inner protrusions 156 increase contact surface between the wear element 150d and the resilient body 140, which can improve the overall anchoring of the wear element 150d and the resilient body 140. Thus, in some instances, the inner protrusions 156 can be referred to as anchors or anchoring members. It is to be noted that the enlarged portions 158, which are disposed at respective ends of the inner protrusions 156, can further assist in anchoring the wear element 150d by providing a mechanical interlock when compared with the wear elements 150a, 150b. Also, in some cases, the inner protrusions 156 can act as a heat sink, such that the heat generated by friction between the wear element 150d and the endless track 70 can be dissipated, at least partially, within the resilient body 140. This can assist in extending life of the wear element 150d. In the present embodiment, the inner protrusions 156 extend along an entire circumference of the wear element 150d. It is contemplated, however that there could be a plurality of inner protrusions 156 circumferentially spaced from one another. Although the wear element 150d is illustrated as being a continuous component, it is contemplated that in some instances, the wear element 150d could be made of various segments with gaps between adjacent segments.

With reference to FIG. 10, a fifth embodiment of the wear element 150, namely wear element 150e, will now be described. In this embodiment, the wheel 112a includes five wear elements 150e. It is contemplated that in other embodiments, the wheel 112a could include more or fewer than five wear elements 150e. Each of the five wear elements 150e is a ring with a circular cross-section. Other cross-sections are contemplated. Each of the five wear elements 150e is radially spaced from one another, such that the five wear elements 150e vary in size and are concentric. The five wear elements 150e are spaced from one another by a gap in some cases. It is contemplated that each of the wear elements 150e could be segmented as well, with a gap between adjacent segments in some cases. It is also contemplated that the wear elements 150e could form other shapes than a circle (e.g., sinusoidal shape, zig-zag shape, etc.) such that the wear elements 150e could define a larger area of contact. It is also contemplated that a given one of the wear elements 150e could have a first cross-section and an other one of the wear elements 150e could have a second cross-section different from the first cross-section. In this embodiment, the wear elements 150e can provide more radial flexibility when compared to the wear elements 150a, 150b, 150c, 150d.

With reference to FIG. 11, a sixth embodiment of the wear element 150, namely wear element 150f, will now be described. In this embodiment, the wear element 150f is a circular ring with a circular cross-section. Other cross-sections are contemplated. The wear element 150f has a larger cross-section than the wear elements 150e. In some instances, this increased cross-section can increase contact surface between the wear element 150f and the resilient body 140 when compared with contact surface between the wear elements 150e and the resilient body 140. As a result of the increased contact surface, overall anchoring of the wear element 150f and the resilient body 140 can be improved. Although the wear element 150f is illustrated as being a continuous component, it is contemplated that in some instances, the wear element 150f could be made of various segments with a gap between adjacent segments. It is also contemplated that the wear element 150f could form other shapes than a circle (e.g., sinusoidal shape, zig-zag shape, or the like) such that the wear element 150f could define a larger area of contact for engaging with the lugs 76. For instance, the wear element 150f could have a sinusoidal shape such that it provides an area of contact equivalent to an area of contact defined by the five wear elements 150e.

With reference to FIG. 12, a seventh embodiment of the wear element 150, namely wear element 150g, will now be described. In this embodiment, the wear element 150g is a circular band that has a mesh-like structure which provides a large area of contact configured to engage the lugs 76. Specifically, the wear element 150g includes a plurality of wear element pieces 150g1, and defines a plurality of openings 150g2 that increase flexibility thereof. The mesh-like structure can be formed by a simple pattern (e.g., repetition of one shape of the wear element piece 150g1 and one shape of the opening 150g2) or a complex pattern (e.g., repetition of one or more shapes of component piece 150g1 and/or one or more shapes of opening 150g2). Although the wear element 150g is illustrated as being a continuous component, it is contemplated that in some instances, the wear element 150g could be made of various with gaps between adjacent segments. In some cases, the wear element 150g could be segmented tangentially (i.e., forming a plurality of concentric arcuate segments) and/or radially (i.e., forming a plurality of sectors). It is contemplated that a given one of the plurality of segments could have a first pattern and an other one of the plurality of segments could have a second pattern different from the first pattern.

With reference to FIG. 13, an eight embodiment of the wear element 150, namely wear element 150h, will now be described. In this embodiment, the wear element 150h is a circular band that has plates 160 joined by connectors 162. The connectors 162 define a gap between adjacent plates 160 in some cases. The connectors 162 can improve the flexibility of the wear element 150h. It is contemplated that the plates 160 can include a first plate 160 having a first shape and a second plate 160 having a second shape different from the first shape. In some cases, the wear element 150h can form a simple pattern (e.g., repetition of the first shape of the first plate 160 and the second shape of the second plate 160) or a complex pattern (e.g., repetition of multiple instances of the first shape of the first plate 160 and/or multiple instances of the second shape of the second plate 160). It is also contemplated that the first and second shapes of the first and second plates 160a, 160b could be substantially symmetrical relative to a centerline defined by the circular band of the wear element 150h (i.e., defined by the connectors 162) in some cases and can be asymmetrical in some other cases. It is also contemplated that the plates 160 could all be shaped similarly, but could include some plates 160 radially offset from one another. In such cases, a given one of the plates 160 can be positioned at a first position relative to the centerline, which is defined by the circular band of the wear element 150h, and an other one of the plates 160 can be positioned at a second position relative to the centerline, where the second position is radially offset from the first position, thereby forming a pattern along the circumference of the wear element 150h. Although the wear element 150h is illustrated as being a continuous component, it is contemplated that in some instances, the wear element 150h could be made of various segments with gaps between adjacent segments.

With reference to FIG. 14, a ninth embodiment of the wear element 150, namely wear element 150i, will now be described. In this embodiment, the wear element 150i is a bead that is made of a material having a low coefficient of friction with the endless track 70. In this embodiment, the wheel 112a has a plurality of wear element 150i that are disposed in the resilient body 140 in a controlled fashion, such that distance between different wear elements 150i is substantially similar. It is contemplated that the wear elements 150i could be disposed in the resilient body 140 in a random fashion. Furthermore, while the wear elements 150i in this embodiment are of similarly sized, it is contemplated that the wear elements 150i could be of different sizes. In some implementations of this embodiment, the beads could be replaced or complemented with particles (nanoparticles and/or microparticles) from high wear resistance and low coefficient of friction such as, but not limited to, UHMW, distributed on the surface of the sidewall of the non-pneumatic resilient wheel. In such embodiments, the particles could be regulated under density. For instance, the wear element 150i, as a whole, can define a first portion, corresponding to the beads altogether, having a first density over an area of the side 120a and a second portion, corresponding to the particles, defining a second density over the area of the side 120, where the first density is different from the second density. In some cases, the second density can be determined by dividing a quantity of particles per area unit (when the particles are similarly sized for instance) or by dividing a projected area of particles per area unit (when the particles differ in size for instance). In embodiments where the particles are disposed in the resilient body 140 in a random fashion, the density of particles can be an average of the quantity of particles per area unit.

With reference to FIG. 15, a tenth embodiment of the wear element 150, namely wear element 150j, will now be described. In this embodiment, the wear element 150j is an axially extending wire. In some instances, the wear element 150j could be considered to be a rod. In this embodiment, the wheel 112a has a plurality of wear element 150j that are disposed in the resilient body 140 in a controlled fashion. For example, in the present embodiment, there are four rows of the wear elements 150j that are radially spaced and a plurality of columns that are equally angularly spaced. In the embodiment shown in FIG. 15, the rows for a given column are angularly aligned with one another. In some other embodiments, the rows for a given column could be angularly offset from one another. In some other embodiments, the columns and the rows could be angularly offset from one another, thereby, in some instances, forming a “zig-zag” configuration. Since the wear elements 150j extend axially into the resilient body 140 and define a length, a contact surface between the wear element 150j and the resilient body 140 is increased, which can improve the overall anchoring of the wear element 150j and the resilient body 140. In some embodiments, one or more of the wear elements 150j can span about half of a width of the resilient body 140. For example, the wear elements 150j are initially subjected to wear until the wear elements 150j are flush with the side 120a of the wheel 112a, at which point, the side 120a of the wheel 112b will be subjected to wear. Eventually, the wear thereof will expose the wear elements 150j again, which will decrease wear of the side of the wheel 112a. Thus, the length of the wear elements 150j can extend life thereof. In some embodiments, the length of wear elements 150j can provide better durability of the wear elements 150j and can thus increase the durability of the wheel 112a. Furthermore, in some cases, the wear elements 150j extending axially in the resilient body 140 can act as a heat sink, as heat generated by friction between the wear elements 150j and the endless track 70 can be dissipated, at least partially, within the resilient body 140. It is contemplated that in some embodiments the wear elements 150j could have varying length, such that some of the wear elements 150j have a first length, and other wear elements 150j have a second length, where the first and second lengths are different. It is also contemplated that cross-sectional areas of the wear elements 150j can vary from one wear element to another. For example, some of the wear elements 150 could have a first cross-sectional shape (e.g., a circle, a square, etc.) and other wear elements 150 could have a second cross-sectional shape, where the first and second cross-sectional shapes are different in size and/or in shape from one another. It is understood that such variation in lengths and/or in cross-sectional shapes can define a pattern among the wear element 150j.

With reference to FIG. 16, an eleventh embodiment of the wear element 150, namely wear element 150k, will now be described. In this embodiment, the wear element 150k is a tubular member that extends in the axial direction. The radial thickness of the wear element 150k is such that the wear element 150k is flexible, and can resiliently deform as the wheel 112 deforms. In this embodiment, the wheel 112a has four wear element 150k of varying diameters. It is contemplated that in some embodiments, the wheel 112a could have more or fewer tubular members. The collaboration of the four wear element 150k can significantly increase wheel rigidity by having some foam between each wear element 150k. In some embodiments, this increased rigidity could enable the use of a smaller wheel that could withstand higher loads (while remaining flexible enough to deform). This could reduce manufacturing costs as less material would be required to manufacture the wheel 112a. It is understood that since the wear elements 150k extend axially into the resilient body 140 and define a length, a contact surface between the wear element 150k and the resilient body 140 is increased, which can improve the overall anchoring of the wear element 150k and the resilient body 140. In some embodiments, one or more of the wear elements 150j can span about half of a width of the resilient body 140. Also, as described hereabove with reference to the wear elements 150j, the wear elements 150k advantageously provide wear resistance during a longer period of operation due to an axial length thereof. Also, in some cases, the wear elements 150k extending axially in the resilient body 140 can act as a heat sink, as the heat generated by friction between the wear element 150k and the endless track 70, can be dissipated, at least partially, within the resilient body 140. It is contemplated that in some embodiments the wear elements 150k can have varying length. For example, in some cases, some of the wear elements 150k have a first length, and others of the wear elements 150k have a second length, where the first and second lengths are different. It is understood that such variation in lengths can define a pattern among the wear element 150k. Although each of the wear elements 150k is illustrated as being a continuous component, it is contemplated that in some instances, the wear element 150k could be made of various segments with a gap between adjacent segments. In some cases, the wear element 150k could be segmented tangentially (i.e., forming a plurality of concentric arcuate segments) and/or radially (i.e., forming a plurality of sectors). It is contemplated that a given one of the plurality of segments could have a first pattern and an other one of the plurality of segments could have a second pattern different from the first pattern. In some cases, the segments of a first wear element 150k can be radially offset relative to the segments of a second wear element 150k. It is also contemplated that the wear elements 150k can form other shapes than a circle as well (e.g., sinusoidal shape, zig-zag shape, or the like) such that the wear elements 150k define a larger area of contact.

With reference to FIG. 17, an embodiment of the wear element 150, namely wear element 150l, will now be described. In this embodiment, the wear element 150l is a threaded cap that is configured to be connected to the resilient body 140 of the wheel 112a. In some instances, the wear element 150l could be a hole plug. Specifically, the wear element 150k has a cap portion 150k1 and a connecting portion 150k2. A top of the cap portion 150k1 extends, at least partially, from the side 120a. Furthermore, in this embodiment, the wheel 112a includes a plurality of the wear elements 150l. The wear elements 150l, which are connected on the side 120a, are circumferentially spaced from one another across a circumference of the resilient body 140. It is contemplated that In some embodiments, some of the wear elements 150l could be radially spaced from one another. As such, although in the embodiment illustrated in FIG. 17 the wear elements 150l altogether define a circular shape, it is contemplated that the wear elements 150l could define another shape. It is understood that since the wear elements 150l extend axially into the resilient body 140 and define a length, a contact surface between the wear elements 150l and the resilient body 140 is increased. The contact surface is further increased by the presence of the threads of the wear elements 150l. As such, the overall anchoring between the wear elements 150l and the resilient body 140 is enhanced. Also, the wear elements 150l, due to their length, advantageously provide wear resistance during a longer period of operation, as described hereabove. Thus, as the side of the wheel 112a that is in contact with the lugs 76 is subjected to more wear, the length of wear elements 150l provides improved life of the wear elements 150l and can thus increase the durability of the wheel 112a in some cases. Also, in some cases, the wear elements 150l extending axially in the resilient body 140 can act as a heat sink. The heat generated by friction between the wear elements 150l and the endless track 70 can be dissipated, at least partially, within the resilient body 140. It is contemplated that in some embodiments the wear elements 150l can vary in length from one another. For example, in some cases, some of the wear elements 150l have a first length, and other of the wear elements 150l have a second length, where the first and second lengths are different.

With reference to FIG. 18, a thirteenth embodiment of the wear element 150, namely wear element 150m, will now be described. The wear element 150m is similar to the continuous band 150a. However, the wear element 150m notably differs from the continuous band 150a in that the wear element 150m has a connecting portion 170 and a wear portion 172. The connecting portion 170 is made of a material that is easily connectable to the wheel 112a. In some embodiments, the connecting portion 170 is made of a polymeric material. The wear portion 172 is made of a material having relatively low friction with the endless track 70. In some embodiments, the wear portion 172 is made of UHMW. The connecting and wear portions 170, 172 are connected to one another via overmolding, but it understood that other connection method are contemplated. The connecting portion 170 is useful in that, due to the material characteristics of the wear portion 172 and the wheel 112a, it can be difficult to connect the connecting portion 170 directly to the wheel 112a once said wheel 112a has been molded. It is understood that the lateral and radial thicknesses of the connecting and wear portions 170, 172 could vary from one embodiment to another, so long as the wear element 150m can resiliently deform with the wheel 112a. Furthermore, although the wear element 150m is shown as a continuous circular band, it is contemplated that the wear element 150m could be segmented as well, with a gap between adjacent segments. The segments could be radially spaced from one another, and could form a pattern.

With reference to FIG. 19, the wear element 150m is used with a wheel 112a′. The wheel 112a′ notably differs from the wheel 112a, in that the wheel 112a′ further includes a connecting portion 135. The connecting portion 135 is a connecting layer that is disposed radially between the hub component 130 and the resilient body 140. The connecting portion 135 is made of a material that can easily connect with both the hub component 130 and the resilient body 140 other than then via overmolding. In some embodiments, the connecting portion 135 is made of a polymeric material, and is connected to the hub component 130 and the resilient body 140 via adhesive, such that the connecting portion 135 fixedly connects the hub component 130 to the resilient body 140. Fixedly connecting the hub component 130 with the resilient body 140 can be useful for avoiding friction therebetween. Indeed, in embodiments where the hub component 130 and the resilient body 140 are not fixedly connected, the hub component 130 may, in some instances, such as when subjected to high loads, move relative to the resilient body 140. This movement will cause friction, which could reduce life of said wheel. The wheel 112a′ can assist in overcoming this problem. In some embodiments where the connecting portion 135 is made of a polymeric material, the hub component 130 could be made of UHMW.

It is understood that other embodiments can be created by combining features from described embodiments. In other words, the features described herewith are based on given embodiments are not exclusive thereto. These features can be combined with features or replacement with features of other embodiments.

In some embodiments, the wheel 112a could be impermeable. In some embodiments, the wheel 112a could be configured to be as least dense as possible (i.e., configured to reduce weight thereof). Both impermeability and lightness can be achieved by selecting material having a low density (e.g., polyurethane closed cell foam). Other materials are contemplated as well, as would understand a person skilled in the art.

It is contemplated that in some embodiments, the wear element 150 can be added in the form of a coating including, for example UHMW or ceramic (i.e., low coefficient of friction). In some embodiments, the wear element 150 could be a coating including hard cast urethane.

In another method of manufacturing the wheel 112a, the wheel 112a is assembled/formed by connecting the resilient body 140 to the hub component 130, and then adding the wear element 150 to the resilient body 140. It is understood that in some embodiments, adding the wear element 150 includes adding one, two or three or more of the wear elements to the resilient body 140. In another method of manufacturing of the wheel 112a, the wheel 112a is assembled/formed by connecting the wear element 150 to the resilient body 140, and then connecting the resilient body 140, which is connected to wear element 150, to the hub component 130.

It is to be noted that in some instances, the engagement between the wheels 112a, 112b and the lugs 76 can prevent the endless track 70 from detracking. This can create a dilemma in the conception of a track system, as having support wheels relatively close to lugs of an endless track may be desirable for maintaining lateral alignment of the endless track, and thus avoid detracking. However, this can imply sacrificing life of the support wheels as the support wheels will be subjected to greater wear due to the engagement between the support wheels and the endless track. As will be described in further detail below, the present technology can minimize the drawbacks of such a compromise.

### Track System Configuration/Layout

Referring to FIGS. 4A, 4B and 4C, another aspect of the present technology, a configuration of the track system 20a, will now be described in greater detail. Distances between the lugs 76 and the inner sides 120a, 120b of the wheels 112a, 112b of the idler and support wheel assemblies 60a, 60b, 100a, 100b, 100c have been configured to extend life of the idler and support wheel assemblies 60a, 60b, 100a, 100b, 100c and of the endless track 70. Specifically, a distance between the lugs 76 and the inner sides 120a, 120b of the wheels 112a, 112b of the idler wheel assemblies 60a, 60b is less than a distance between the lugs 76 and the inner sides 120a, 120b of the wheels 112a, 112b of the support wheel assemblies 100a, 100b, 100c. With reference to FIG. 4C, a distance D1 is measured from the inner side 120a of the wheel 112a of the leading idler wheel assembly 60a to a corresponding lateral side of the lugs 76, a distance D2 is measured from the inner side 120a of the wheel 112a of the trailing idler wheel assembly 60b to a corresponding lateral side of the lugs 76, a distance D3 is measured from the inner side 120a of the wheel 112a of the support wheel assembly 100a to a corresponding lateral side of the lugs 76, a distance D4 is measured from the inner side 120a of the wheel 112a of the support wheel assembly 100b to a corresponding lateral side of the lugs 76, and a distance D5 is measured from the inner side 120c of the wheel 112a of the support wheel assembly 100a to a corresponding lateral side of the lugs 76. While the distances D1, D2, D3, D4, D5 are described with reference to the wheels 112a, it is understood that corresponding distances can be measured for the wheels 112b and their corresponding lateral side of the lugs 76.

In the illustrated embodiment, the distances D2, D3 and D4 are the same, and are between about 9 mm and about 12 mm. It is also contemplated that the distances D3, D4, D5 could be different from one another. The distances D1, D2 are the same and are between about 2 mm to about 3 mm. It is contemplated that the distances D1, D2 could be different from one another. It is contemplated that the distances D1, D2, D3, D4, D5 may vary to some extent. In some embodiments, the distances D3, D4, D5 can be about 4 times greater than the distances D1, D2. In other embodiments, the distances D3, D4, D5 can be about 4.5 times greater than the distances D1, D2.

Since the distances D1, D2 are smaller than distances D3, D4, D5 (i.e., the inner sides 120a, 120b of the idler wheel assemblies 60a, 60b are closer to corresponding lateral surfaces of the lugs 76 than the inner sides 120a, 120b of the support wheel assemblies 100a, 100b, 100c), the idler wheel assemblies 60a, 60b are primary guides for the lateral movement of the endless track 70, and the support wheel assemblies 100, 100b, 100c are secondary guides. Thus, when the endless track 70 moves laterally less than a given amount, for example due to the application of an external load, the idler wheel assemblies 60a, 60b guide the endless track 70 by abutting the lugs 76. When the endless track 70 moves laterally more than the given amount (i.e., lateral movement exceeds a limit), the support wheel assemblies 100a, 100b, 100c guide the endless track 70 by abutting the lugs 76. It is understood that in this configuration, the idler wheel assemblies 60a, 60b are subjected to greater wear resulting from guiding the endless track 70 than the support wheel assemblies 100a, 100b, 100c, but this can be advantageous since the wheels 112a, 112b of the support wheel assemblies 100a, 100b, 100c can generally wear out faster than the wheels 112a, 112b of the idler wheel assemblies 60a, 60b due to the loads the support wheel assemblies 100a, 100b, 100c are subjected to. In addition, in embodiments where the wheels 112a, 112b of the idler and support wheel assemblies 60a, 60b, 100a, 100b, 100c are similar in width, the inner sides 120a, 120b of the support wheel assemblies 100a, 100b, 100c being further from corresponding lateral surfaces of the lugs 76 than the inner sides 120a, 120b of the idler wheel assemblies 60a, 60b (i.e., the inner sides 120a, 120b of the wheels 112a, 112b of the idler wheel assemblies 60a, 60b being laterally offset from the corresponding inner sides 120a, 120b of the wheels 112a, 112b of the support wheel assemblies 100a, 100b, 100c) can assist in distributing the load sustained by the idler and support wheel assemblies 60a, 60b, 100a, 100b, 100c across a greater lateral width of the endless track 70. This can decrease wear of the endless track 70 and/or of the wheels 112a, 112b. This is notably advantageous in that support wheel assemblies 100a, 100b, 100c are generally subjected to numerous stresses (sustaining weight of the vehicle, absorbing impacts, guiding the endless track, etc.), which can result in the support wheel assemblies 100a, 100b, 100c quicky wearing out and needing replacement. The present configuration causes the idler wheel assemblies 60a, 60b to be the primary guides of the endless track 70, such that stresses on the support wheel assemblies 100a, 100b, 100c are reduced. As a result, they can be subjected to less wear, and thus need to be replaced less often.

Through analysis and tests, it has been observed that this configuration provides a better resistance to detracking than conventional configurations. In other words, better control of the lateral movement of the endless track 70 can be obtained by increasing the distance between the inner sides 120a, 120b of the wheels 112a, 112b of the support wheel assemblies 100a, 100b, 100c, and by decreasing the distance between the inner sides 120a, 120b of the wheels 112a, 112b of the idler wheel assemblies 60a, 60b. The better resistance to detracking can further be enhanced when combined with more rigid endless tracks 70 (e.g., an endless track made of stiffer resilient material and/or more reinforcing elements within its carcass). This can be observed by performing finite element analysis (FEA). In operation, the endless track 70 is primarily guided with the idler wheel assemblies 60a, 60b, and the lateral rigidity of the endless track 70 reduces the likelihood of the endless track 70 from contacting the support wheel assemblies. Thus, at sufficiently high loads, the endless track 70 may contact the support wheel assemblies 100a, 100b, 100c, which through contact, can recenter the endless track 70, and thereby prevent detracking. Delaying the endless track from coming into contact with the support wheel assemblies allows to reduce wear on the lugs 76.

In FIGS. 3A, 3B and 3C, the distances D4, D5 (which are the same) are smaller than the distances D1, D2 (which are the same), and the distance D3 is greater than the distances D1, D2, D4, D5. In some embodiments, the distances D1, D2 can be about 4.5 mm, the distance D3 can be about 6 mm, and the distances D4, D5 can be about 3 mm. It is understood that the distances could vary from one track system to another.

In this embodiment, the support wheel assemblies 100b, 100c are subjected to greater wear than the support wheel assembly 100a, and the idler wheel assemblies 60a, 60b, as the support wheel assemblies 100b, 100c are the primary endless track 70 guides. However, the support wheel assemblies 100b, 100c having the wear element 150 can assist in extending their lives, as when the support wheel assemblies 100b, 100c engage with the lugs 76 due to the deformation of the endless track 70, it is the wear elements 150 that engages the lugs 76, rather than the resilient body 140.

### Operation

With reference to FIGS. 4A and 4B, the track system 20a in operation will now be described in greater detail. Although the operation is described with reference to the wheels 112a, 112b it is understood that the wheels 212a, 312a may be used as well.

When the track system 20 is overcoming an obstacle, or travelling on a sloped surface, the endless track 70 may move relative to the idler and support wheel assemblies 60a, 60b, 100a, 100b, 100c. This can be a result of the endless track 70 being subjected to one or more external forces, and/or one or more of the idler and support wheel assemblies 60a, 60b, 100a, 100b, 100c, which may be pivotally connected to the frame 50, pivoting about a longitudinal axis. Furthermore, due to the deformable nature of the wheels of the idler and support wheel assemblies 60a, 60b, 100a, 100b, 100c, one or more of the wheels 112a, 112b of the idler and support wheel assemblies 60a, 60b, 100a, 100b, 100c may resiliently deform while overcoming the obstacle or travelling on the sloped surface. The wear elements 150 connected to the wheels 112a, 112b are configured to not impede on the deformable and resilient nature of the wheels 112a, 112b. In some instances, the wear elements 150 are configured so that the wheels 112a, 112b, upon application of a load, are deformable by a generally same amount regardless of the presence or absence of the wear elements 150.

As a result of the relative movement between the idler and support wheel assemblies 60a, 60b, 100a, 100b, 100c and the endless track 70, the endless track 70 may come in engagement with one or more of the idler and support wheel assemblies 60a, 60b, 100a, 100b, 100c. Specifically, in the embodiment illustrated in FIGS. 4A and 4B, since the idler wheel assemblies 60a, 60b are closer to the lugs 76 than the support wheel assemblies 100a, 100b, 100c, the idler wheel assemblies 60a, 60b will engage with the endless track 70 before the support wheel assemblies 100a, 100b, 100c. Specifically, one of the wheels 112a, 112b of the idler wheel assemblies 60a, 60b will engage with a lateral surface of the lugs 76 (depending on the direction of movement between the endless track 70 and the idler and support wheel assemblies 60a, 60b, 100a, 100b, 100c). As mentioned above, the wheels 112a, 112b of the idler wheel assemblies 60a, 60b are equipped with the wear element 150. As such, when the endless track 70 does come into contact with the one of the wheels 112a, 112b of the idler wheel assemblies 60a, 60b, the endless track 70 engages the wear element 150 rather than the resilient body 40, such that the wear element 150 is subjected to wear rather than the resilient body 140. Furthermore, it is to be noted that if the one of the wheels 112a, 112b of the idler wheel assemblies 60a, 60b were to be subjected to deformation, the presence of the wear element 150 would not impact the deformation thereof.

In some embodiments, the engagement between the one of the wheels 112a, 112b

of the idler wheel assemblies 60a, 60b is sufficient to re-center the endless track 70, and prevent detracking. As the idler wheel assemblies 60a, 60b are the primary guides of the endless track 70, life of the support wheel assemblies 100a, 100b, 100c is extended as they are less likely to engage with the endless track 70.

In some embodiments, the lateral rigidity of the endless track 70 can been increased,

thereby further reducing the likelihood of the endless track 70 of engaging the support wheel assemblies 100a, 100b, 100c.

In some instances, however, despite the engagement between the endless track 70 and the idler wheel assemblies 60a 60b, and despite the lateral rigidity of the endless track 70, the endless track 70 can still move by an additional amount, at which point, the endless track 70 may engage one or more of the support wheel assemblies 100a, 100b, 100c. This engagement can assist in centering the endless track 70, and reduce the likelihood of detracking. As the support wheel assemblies 100a, 100b, 100c are equipped with the wear element 150, life of the support wheel assemblies 100a, 100b, 100c and the endless track 70 is extended.

1. A resilient component for a wheel of a track system, the resilient component comprising:
a resilient body defining a hub aperture for at least partially receiving a hub component, the resilient body extending radially outwardly from the hub aperture, and defining a first lateral sidewall and a second lateral sidewall, the first and second lateral sidewalls being spaced apart; and
a wear element connectable to one of the first and second lateral sidewalls, the wear element at least partially surrounding the hub aperture and projecting at least partially from the one of the first and second lateral sidewalls.

2. The resilient component of claim 1, wherein:
the resilient body is deformable by a first amount when the wear element is disconnected from the resilient body;
the resilient body is deformable by a second amount when the wear element is connected to the resilient body; and
the first amount is generally similar to the second amount.

3. The resilient component of claim 1, wherein:
the resilient body has a first modulus of elasticity when the wear element is disconnected from the resilient body;
the resilient body has a second modulus of elasticity when the wear element is connected to the resilient deformable body; and
the first modulus of elasticity is generally similar to the second modulus of elasticity.

4. The resilient component of claim 1, wherein the wear element is deformable.

5. The resilient component of claim 1, wherein the wear element includes an anchoring portion for anchoring the wear element to the resilient body.

6. The resilient component of claim 6, wherein the anchoring portion extends in at least one of a radial direction of the resilient component and an axial direction of the resilient component.

7. The resilient component of claim 1, wherein the wear element is a wear ring.

8. The resilient component of claim 10, wherein the wear ring has one of: a circular cross-section and a rectangular cross-section.

9. The resilient component of claim 1, wherein the wear element extends axially within the resilient body by about half of an axial length of the resilient body.

10. The resilient component of claim 1, wherein the resilient component comprises a plurality of wear elements, and the wear element is one of the plurality of wear elements.

11. The resilient component of claim 10, wherein each one of the plurality of wear elements is a spherical wear element.

12. The resilient component of claim 1, wherein the resilient body is connectable to the hub component by at least one of a chemical bond, a mechanical interlock and an interference fit.

13. The resilient component of claim 1, wherein the resilient body includes at least two strengthening folds.

14. A resilient wheel for a track system, the resilient wheel comprising:
a hub component; and
the resilient component of claim 1 connected to the hub component.

15. The resilient wheel of claim 14, wherein the resilient wheel is a non-pneumatic wheel.

16. The resilient wheel of claim 14, wherein the resilient wheel is part of one of: an idler wheel assembly and a support wheel assembly.

17. The resilient wheel of claim 14, wherein:
the resilient wheel further comprises a retaining ring;
the hub component includes a retaining portion for engaging with the retaining ring; and
the retaining ring being configured to axially retain the resilient body to the hub component.

18. A track system comprising:
a frame;
at least one wheel assembly comprising a wheel according to claim 14, the at least one wheel assembly being connected to the frame; and
an endless track surrounding the frame and the at least one wheel assembly.

19. A track system comprising:
a frame;
at least one idler wheel assembly connected to the frame, the at least one idler wheel assembly including at least one resilient wheel including:
a first hub component; and
a first resilient component including:
a first resilient body defining a first hub aperture for receiving the first hub component, the first resilient body extending radially outwardly from the first hub aperture so as to define a first lateral sidewall and a second lateral sidewall, the first and second lateral sidewalls being spaced apart; and
a first wear element connected to one of the first and second lateral sidewalls, the first wear element surrounding, at least partially, the first hub aperture and projecting at least partially from the one of the first and second lateral sidewalls;
at least one support wheel assembly connected to the frame, the at least one idler wheel assembly including at least one resilient wheel including:
a second hub component; and
a second resilient component including:
a second resilient body defining a second hub aperture for receiving the second hub component, the second resilient body extending radially outwardly from the second hub aperture so as to define a third lateral sidewall and a fourth lateral sidewall, the third and fourth lateral sidewalls being spaced apart; and
a second wear element connected to one of the third and fourth lateral sidewalls, the second wear element surrounding, at least partially, the second hub aperture and projecting at least partially from the one of the third and fourth lateral sidewalls.
an endless track surrounding the frame, the at least one idler wheel assembly and the at least one support wheel assembly, the endless track comprising a plurality of longitudinally spaced lugs,
a lateral distance between one of first and second lateral sidewalls and a corresponding lateral surface of one of the plurality of lugs is less than a lateral distance between a corresponding one of the third and fourth lateral sidewalls and a corresponding lateral surface of one of the plurality of lugs.

20. A method for manufacturing a resilient component for a resilient wheel of a track system, the method comprising:
forming a resilient body configured to be connectable to a hub component;
connecting a wear element to the resilient body; and
connecting the resilient body to a hub component.
